(19) United States
(12) Patent Application Publication
(10) Pub. No.: US 2025/0360603 A1
(43) Pub. Date: Nov. 27, 2025

(54) MODULE INSTALLATION TOOLS AND ASSOCIATED METHODS

(71) Applicant: Thermo Finnigan LLC, San Jose, CA (US)

(72) Inventors: Nicholas A. Pedrazas, Austin, TX (US); Dustin Holden, Austin, TX (US)

(73) Assignee: Thermo Finnigan LLC, San Jose, CA (US)

(21) Appl. No.: 18/670,574

(22) Filed: May 21, 2024

(51) Int. Cl. B25B 27/14; H01J 49/04; H01J 49/10

(52) U.S. Cl. CPC B25B 27/14; H01J 49/0495; H01J 49/10

(57) ABSTRACT

Module installation tools and associated methods are disclosed herein. In an example, a module installation tool includes a tool head, a tool base, and an actuator. The module installation tool is configured such that axial motion of the actuator relative to the tool base causes the tool head to rotate relative to the tool base to couple a module to a module receiver or to uncouple the module from the module receiver. In an example, a method includes translating an actuator of a module installation tool in a proximal direction to bring the module into engagement with a module receiver and further translating the actuator in the proximal direction to rotate the tool head relative to the module receiver.

### FIELD

The present disclosure relates generally to module installation tools and associated methods, and more specifically to tools and methods for installing a module in a vacuum system.

### BACKGROUND

Various apparatuses such as mass spectrometers commonly use a vacuum interlock system to install or uninstall components within the system with a vacuum interlock tool without the need to vent the vacuum chamber. In some examples, such a vacuum interlock tool may require a user to follow a precise sequence of steps to ensure proper component installation and uninstallation and/or to avoid damage to equipment.

### SUMMARY

In a representative example, an apparatus includes a tool head, a tool base, and an actuator slidably coupled to the tool base. The tool head is configured to engage and support a module that is configured to be selectively coupled to a module receiver. The apparatus is configured such that axial motion of the actuator relative to the tool base causes the tool head to rotate relative to the tool base to couple the module to the module receiver or to uncouple the module from the module receiver.

In another representative example, an apparatus comprises a tool head, a tool base, an actuator slidably coupled to the tool base, and an inner slider at least partially received within the tool base. The tool head is configured to engage and support a module that is configured to be selectively coupled to a module receiver. The inner slider is configured to translate relative to each of the tool base and the tool head. Moving the actuator relative to the tool base causes the inner slider to translate relative to the tool base. The apparatus is configured such that moving the actuator axially relative to the tool base transitions the apparatus among a plurality of configurations defined between and including a retracted configuration and an extended configuration. When in the apparatus is in the retracted configuration, the tool head is in a first axial position relative to the tool base. When the apparatus is in the extended configuration, the tool head is in a second axial position relative to the tool base that is displaced from the first axial position along a proximal direction. The apparatus is configured to rotate the tool head relative to the tool base while the tool head remains in the second axial position.

In another representative example, a method includes, with a module operatively coupled to a tool head of a module installation tool, translating an actuator of the module installation tool in a proximal direction from an initial actuator position to a second actuator position to bring the module into engagement with a module receiver. The method additionally includes translating the actuator in the proximal direction from the second actuator position to a third actuator position to rotate the tool head relative to the module receiver in an installation rotational direction to at least partially couple the module to the module receiver and detaching the module from the tool head.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a perspective view of a module installation tool according to an example.

FIG. 2 is a cross-sectional side view of the module installation tool of FIG. 1 as viewed along the line 2-2 in FIG. 1.

FIG. 3A is a side view of the module installation tool of FIG. 1-2 with an actuator in a first actuator position according to an example.

FIG. 3B is a side view of the module installation tool of FIGS. 1-3A with the actuator in a second actuator position according to an example.

FIG. 3C is a side view of the module installation tool of FIGS. 1-3B with the actuator in a third actuator position according to an example.

FIG. 4A is a side view of a tool head with a tool head guide track and with arrows indicating an installation path of the tool head guide track according to an example.

FIG. 4B is a side view of the tool head of FIG. 4A with arrows indicating a removal path of the tool head guide track according to an example.

FIGS. 5A-5E are a series of side views of a proximal region of a module installation tool depicting a procedure in which the module installation tool is used to install a module according to an example.

FIGS. 6A-6E are a series of side views of proximal region of a module installation tool depicting a procedure in which the module installation tool is used to remove a module according to an example.

FIGS. 7A-7C are a series of cross-sectional side views of a proximal region of a module installation tool depicting operation of a tool head interlock of a tool head of the module installation tool according to an example.

FIG. 8A is a cross-sectional side view of a module installation tool with a valve interlock in a locked configuration according to an example.

FIG. 8B is a cross-sectional side view of the module installation tool of FIG. 8A with the valve interlock in an unlocked configuration according to an example.

FIG. 9 is a perspective view of a slider position interlock and an inner slider of a module installation tool according to an example.

FIGS. 10A-10D are a series of schematic side views depicting operation of a valve interlock of a module installation tool during a procedure of removing a module according to an example.

FIG. 11 is a flow chart depicting a method of installing a module with a module installation tool according to an example.

FIG. 12 is a flow chart depicting a method of removing a module with a module installation tool according to an example.

### DETAILED DESCRIPTION

The present disclosure generally is directed to tools and methods for installation and extraction of components within a system in a manner that facilitates easy and straightforward operation by a user. The tools and methods disclosed herein may be particularly relevant to systems that employ a vacuum interlock to selectively couple various components to the system while at least a portion of the system remains under vacuum. For example, a mass spectrometer system can include a vacuum interlock system that allows a user to install or uninstall components (e.g., ion sources) within the system without the need to vent the vacuum chamber.

When installing a component via a vacuum interlock system, it may be necessary to position the component at a precise location and/or to rotate the component within the system without directly manipulating the component. In some traditional examples, a vacuum interlock tool for installing a component via a vacuum interlock system is used to position and/or move (e.g., rotate) the component within the system to install the component within the system or remove the component from the system. In particular, it may be necessary for a user to manipulate such a vacuum interlock tool to position the component at a specific depth within the system and to rotate the component relative to the system only when the component is in the proper position. In some examples, such a procedure requires the user to perform a sequence of operations with the vacuum interlock tool with sufficient precision to avoid damage to the component and/or to the system.

By contrast, the tools and methods disclosed herein can be used for the installation and/or removal of components within such systems with minimal skill required by the operator and with diminished risk of misuse or damage. As described in more detail herein, examples of module installation tools according to the present disclosure can include a dual-position mechanism that allows for the coupling and uncoupling of components to and from the module installation tool using a single-direction actuation input. In particular, instead of requiring a user to manipulate the tool through a defined path for latching or unlatching, the end of the tool rotates automatically between the locked and unlocked positions in response to axial motion of a component of the tool.

For example, to install a module, a user may insert the module installation tool with component attached into a system and advance an actuator until the actuator stops and subsequently retract the actuator to its original position. To uninstall the module, the user may advance the actuator again until it stops and then retract the actuator such that the module is attached to and received within the module installation tool. In this manner, both the installation and removal operations may require insertion and/or axial translation with the module installation tool until a stop position is reached, followed by extraction of the module installation tool. This can significantly simply the required user interaction and mitigate the chance for error.

As used herein, the term “module” can refer to any suitable apparatus, component, and/or structure that is to be selectively and operatively coupled to and/or removed from another system, apparatus, component, structure, etc. in the manner described herein. The present disclosure generally relates to examples in which the module is a component of a mass spectrometry system, such as an ion source. This is not required, however, and it additionally is within the scope of the present disclosure that the tools and methods disclosed herein may be used in conjunction with any suitable modules, components, systems, etc.

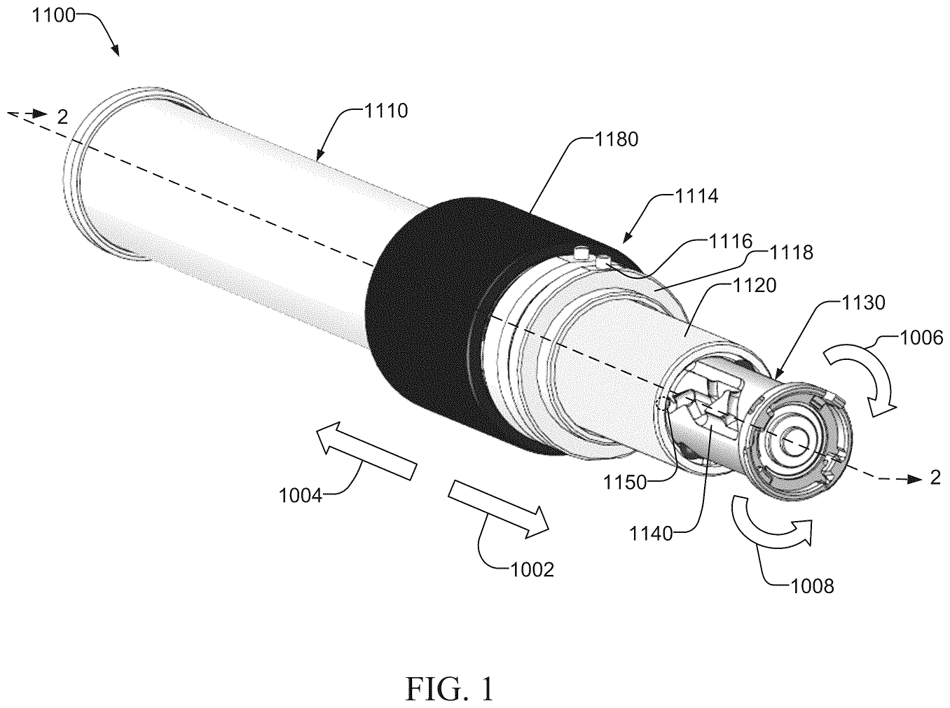

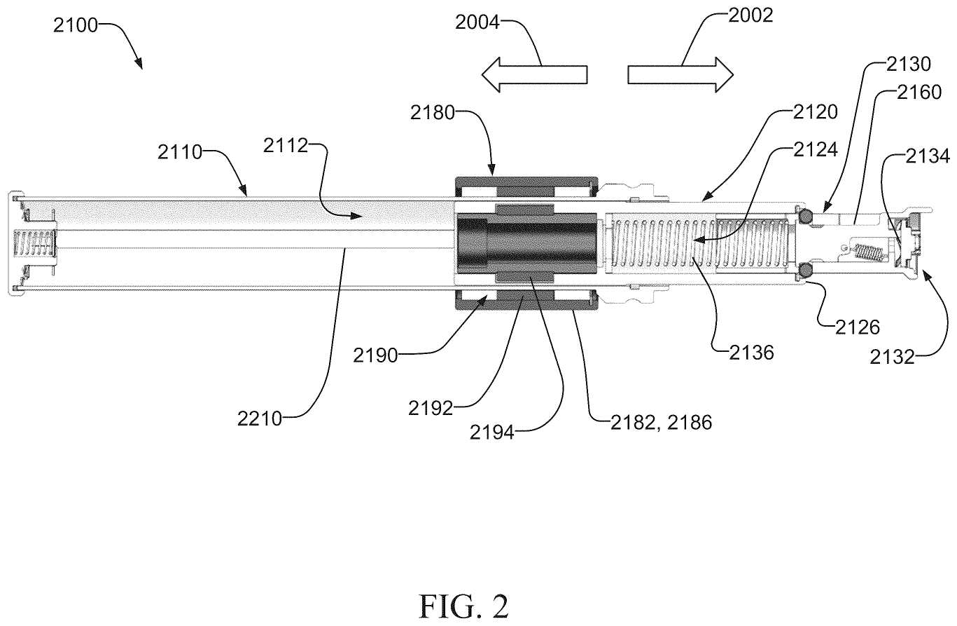

FIG. 1 illustrates an example of a module installation tool 1100 according to the present disclosure, while FIG. 2 is a cross-sectional view of the module installation tool of FIG. 1 as viewed along the line 2-2 in FIG. 1. In the present disclosure and in the figures, reference numerals labeling components and/or steps are formatted such that the leading digit(s) of the reference numeral correspond to the figure in which the component and/or step appears and such that the remaining three digits represent an identifier corresponding to the particular component and/or step. In this manner, reference numerals with like identifiers may be used to label like components and/or steps in the figures. For example, for those components labeled in FIG. 2, components labeled with a reference numeral of the form “2XX” are intended to correspond with the components labeled with a reference numeral of the form “1XX” in FIG. 1. As a more specific example, the module installation tool 2100 of FIG. 2 corresponds to, and may be at least substantially identical to, the module installation tool 1100 of FIG. 1. Unless otherwise stated, all illustrated components of any figure, labeled or unlabeled, can share any suitable features, characteristics, attributes, etc. with the corresponding components of any other figure.

As shown in FIG. 1, the module installation tool 1100 includes a tool head 1130, a tool base 1110, and an actuator 1180 slidably coupled to the tool base 1110. The tool head 1130 is configured to engage and support a module that is configured to be selectively coupled to and/or removed from a module receiver as described in more detail below. The module installation tool 1100 generally is configured such that axial motion of the actuator 1108 relative to the tool base 1110 causes the tool head 1130 to rotate relative to the tool base 1110 to couple the module to the module receiver or to uncouple the module from the module receiver.

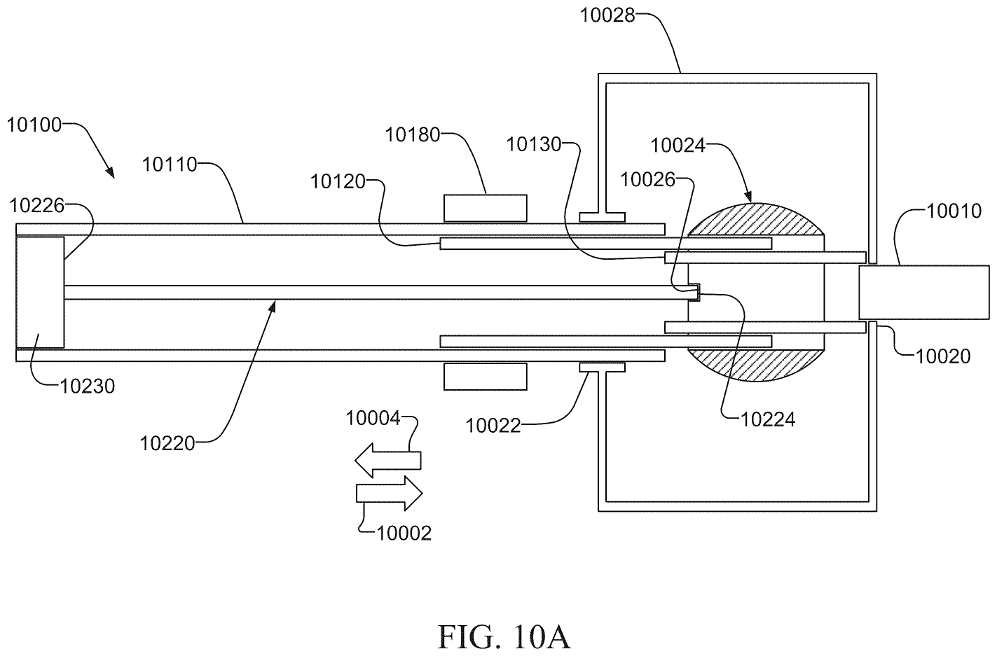

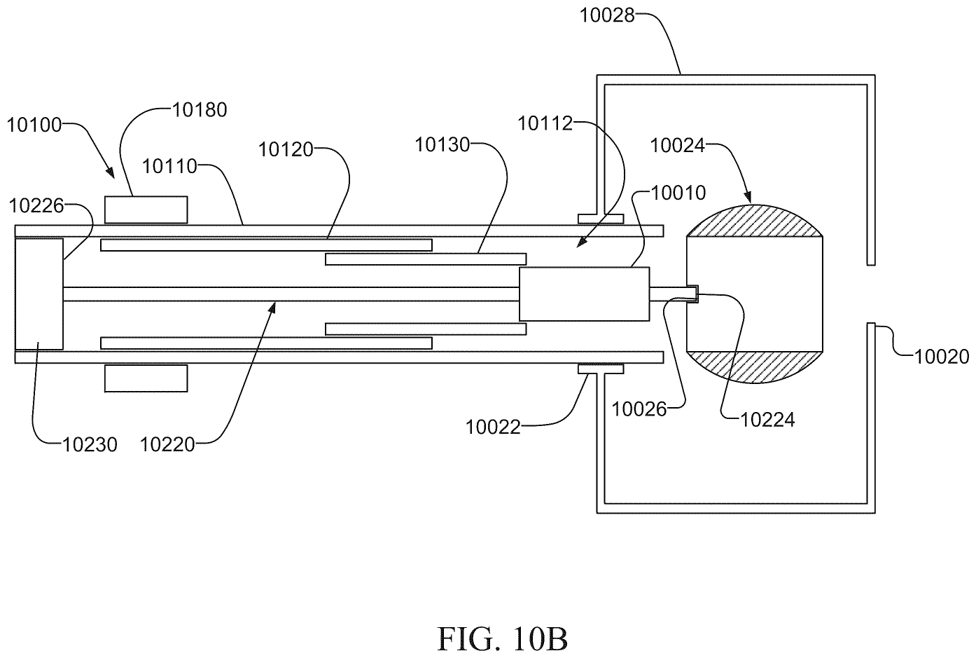

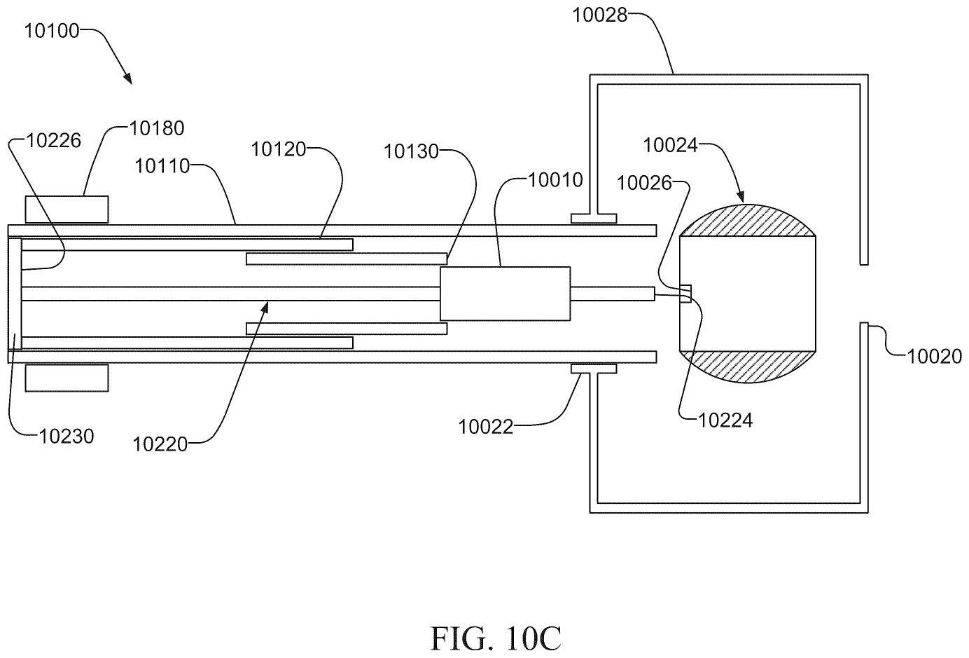

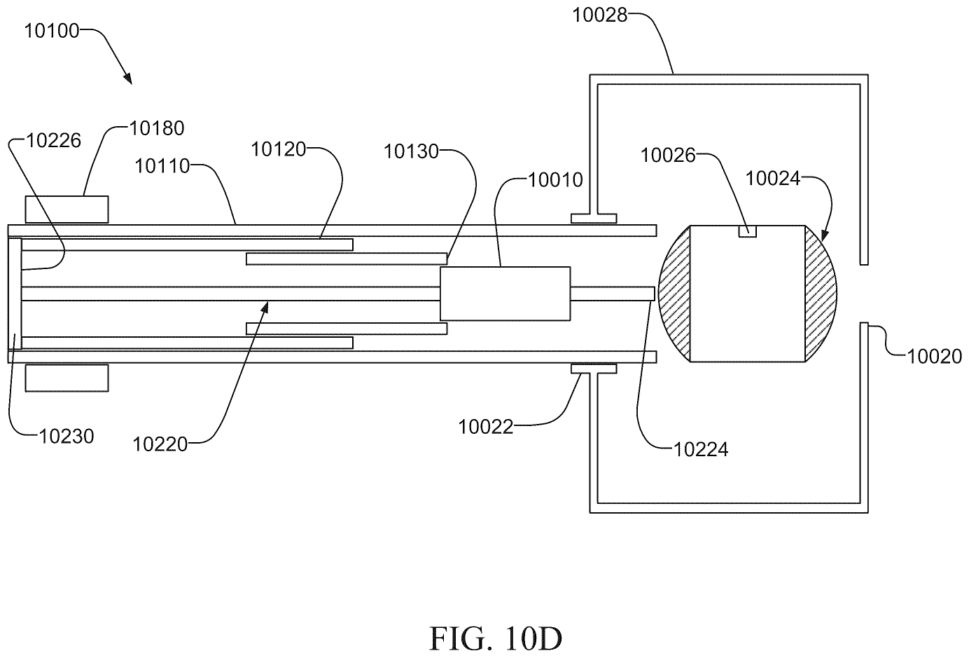

The tool base 1110 can be configured to support the tool head 1130 relative to the module receiver during various operations as described herein. In particular, and as discussed in more detail below (e.g., with reference to FIGS. 10A-10D), the tool base 1110 can be configured to be operatively coupled to a tool receiver that is spaced apart from the module receiver to support the module installation tool 1100 relative to the module receiver.

In the example of FIG. 1, the tool base 1110 includes a tool receiver mating mechanism 1114 configured to selectively couple the tool base 1110 to the tool receiver. In particular, in this example, the tool receiver mating mechanism 1114 includes an alignment feature 1116 in the form of a plurality of alignment pins that are configured to rotationally align the tool base 1110 relative to the tool receiver. The tool receiver mating mechanism 1114 additionally can include a sealing surface 1118 of the tool base 1110 that is configured to form an airtight seal against the tool receiver.

In the present disclosure, terms such as “axial translation,” “axial motion,” and/or “axially” are intended to refer to motion along a direction that is aligned with a central longitudinal axis of the module installation tool 1100. In some examples, and with reference to FIG. 1, such motion may correspond to and/or may be described as motion along a proximal direction 1002 and/or a distal direction 1004. In particular, the proximal direction 1002 corresponds to a direction parallel to the central longitudinal axis of the module installation tool 1100 and directed toward the tool head 1130 (and/or toward a module operatively coupled to the tool head 1130) when the tool head 1130 extends away from the tool base 1110 as in FIG. 1. Similarly, the distal direction 1004 corresponds to a direction parallel to the central longitudinal axis of the module installation tool 1100 and opposed to the proximal direction 1002.

In the present disclosure, relative motion between any components may be described with reference to the perspective of any such component and/or of any other component. In this manner, a description of a motion (e.g., translation and/or rotation) of a first component relative to a second component in a first direction equivalently may be understood as referring to motion of the second component relative to the first component in a second direction that is opposite to the first direction.

As shown in FIG. 1, the module installation tool 1100 can include an inner slider 1120 that is configured to translate axially relative to each of the tool base 1110 and the tool head 1130. The module installation tool 1100 can be configured such that axial translation of the inner slider 1120 relative to the tool head 1130 causes rotation of the tool head 1130 relative to the tool base 1110.

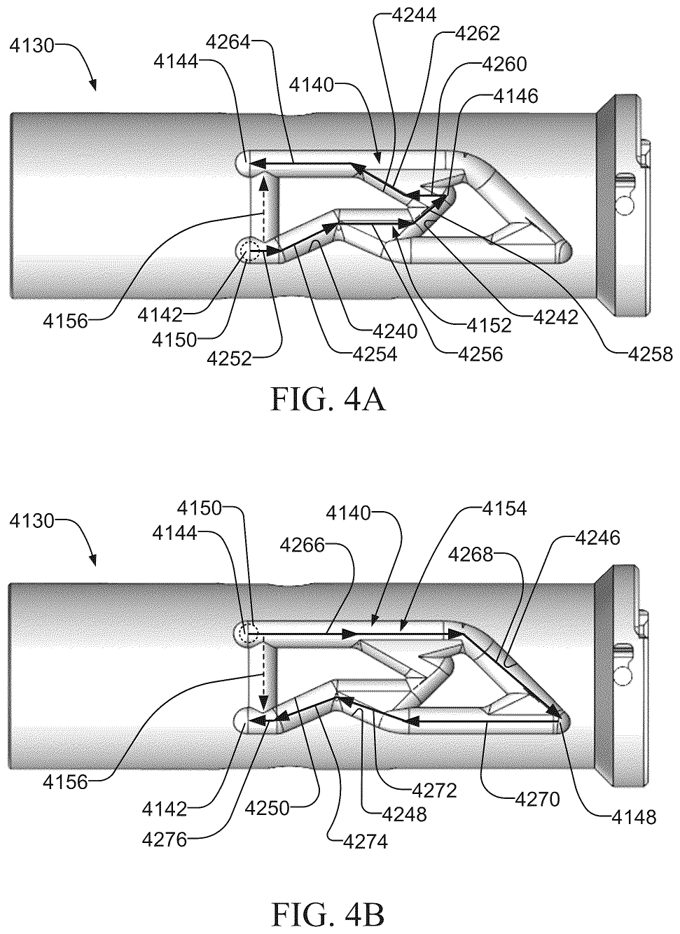

As discussed in more detail below, the inner slider 1120 can cause rotation of the tool head 1130 via interaction of a tool head rotation driver 1150 (hidden from view in FIG. 1 and represented in dashed lines) and a tool head guide track 1140 defined by the tool head 1130. Specifically, the tool head rotation driver 1150 can be fixed in position (e.g., axially and/or rotationally fixed) relative to the inner slider 1120 such that translating the inner slider 1120 axially relative to the tool head 1130 causes the tool head rotation driver 1150 to travel along the tool head guide track 1140, thereby causing the tool head 1130 to rotate relative to the inner slider 1120. As discussed in more detail below with reference to FIGS. 4A-6E, the axial translation of the inner slider 1120 relative to the tool head 1130 can cause the tool head 1130 to rotate in either of an installation rotational direction 1006 or a removal rotational direction 1008 depending upon an initial position of the tool head rotation driver 1150 relative to the tool head guide track 1140.

In the example of FIG. 1, the tool head guide track 1140 takes the form of a channel formed in the tool head 1130, while the tool head rotation driver 1150 takes the form of a ball bearing that is fixed in position relative to the inner slider 1120 and that travels along a path defined by the channel as the inner slider 1120 moves relative to the tool head 1130. In this manner, the tool head rotation driver 1150 may be described as being captively supported by the inner slider 1120 such that the tool head rotation driver 1150 can rotate (e.g., roll) in position relative to the inner slider 1120. This is not required of all examples, however. For example, it also is within the scope of the present disclosure that the tool head guide track 1140 additionally or alternatively can be at least partially defined by an inner surface of the inner slider 1120. As another example, the tool head rotation driver 1150 can be fixedly coupled to the inner slider 1120. As another example, the tool head rotation driver 1150 instead can be fixed in position relative to the tool head 1130 (e.g., fixedly coupled to the tool head 1130 and/or captively supported by the tool head 1130). In various other examples, the tool head rotation driver 1150 can take any suitable form, such as a pin or a protrusion.

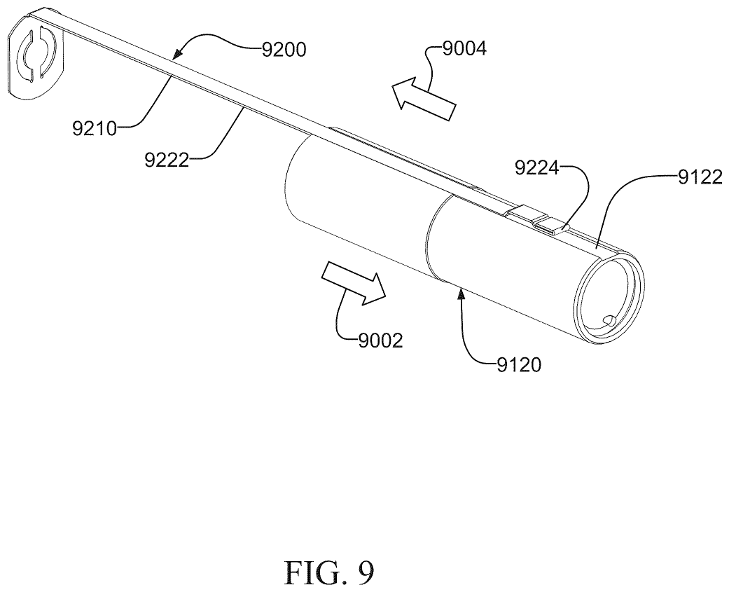

As shown in FIG. 2, the inner slider 2120 can be at least partially received within the tool base 2110, such as within a base inner cavity 2112 of the tool base 2110. The inner slider 2120 can be restricted and/or prevented from rotating relative to the tool base 2110, such as via engagement with a slider track 2210 extending within the base inner cavity 2112. In particular, the slider track 2210 can be rotationally fixed relative to the tool base 2110, and the inner slider 2120 can be configured to translate axially along the slider track 2210 without rotating relative to the slider track 2210. The interaction between the inner slider 2120 and the slider track 2210 is described in more detail below with reference to FIG. 9.

The module can be configured to be operatively coupled to a tool head end region 2132 of the tool head 2130 via any suitable coupling mechanism, such as a coupling mechanism that causes the module to be operatively coupled to or removed from the tool head 2130 via relative rotation therebetween. In some examples, and as shown in FIG. 2, the tool head 2130 includes a module biasing spring 2134 that operates to bias the module in the proximal direction 2002 relative to the tool head 2130 when the module is operatively coupled to the tool head 2130. In this manner, the module biasing spring 2134 can maintain the module in positive engagement with the tool head 2130 to restrict the module from being inadvertently removed from the tool head 2130.

The module installation tool 1100 can be configured such that moving the actuator 2180 relative to the tool base 2110 causes the inner slider 2120 to translate relative to the tool base 2110 in a similar manner. In particular, in the example of FIG. 2, the actuator 2180 and the inner slider 2120 are coupled to one another via a magnetic coupling mechanism 2190 such that the actuator 2180 and the inner slider 2120 can translate in unison. In this example, the tool base 2110 extends between the actuator 2180 and the inner slider 2120 such that the magnetic coupling mechanism 2190 represents a non-contact coupling mechanism between the actuator 2180 and the inner slider 2120. This is not required, however, and it additionally is within the scope of the present disclosure that the actuator 2180 and the inner slider 2120 can be in contact with one another.

In the example of FIG. 2, the magnetic coupling mechanism 2190 includes an actuator magnet 2192 fixedly coupled to the actuator 2180 and an inner slider magnet 2194 fixedly coupled to the inner slider 2120 such that the actuator magnet 2192 and the inner slider magnet 2194 are magnetically attracted to one another through the tool base 2110. The actuator magnet 2192 and the inner slider magnet 2194 can include and/or be any suitable magnets, such as rare earth magnets (e.g., neodymium magnets). In some examples, the actuator magnet 2192 and/or the inner slider magnet 2194 includes one or more arc-shaped magnets extending at least partially circumferentially around a central longitudinal axis of the module installation tool 2100.

In the example of FIG. 2, the actuator 2180 additionally includes and/or is a magnetic shield 2186 that at least partially shields a region exterior of the actuator 2180 from magnetic fields produced by the magnetic coupling mechanism 2190. For example, the magnetic shield 2186 can include and/or be a soft magnetic material (e.g., a ferritic material) that operates to restrict magnetic fields from extending exterior of the actuator 2180 and/or that enhances a magnitude of magnetic fields interior of the actuator 2180.

In other examples, the magnetic coupling mechanism 2190 can include two or more rings of magnets with alternating pole orientations to further enhance the magnetic coupling strength.

In the example of FIG. 2, the actuator 2180 includes an outer sleeve 2182 that is configured to be gripped by a user to move the actuator 2180 and that includes and/or is the magnetic shield 2186. In other examples, the magnetic shield 2186 may be positioned radially interior of the outer sleeve 2182.

In some examples, the magnetic coupling mechanism 2190 can operate to at least partially decouple motion of the actuator 2180 from motion of the inner slider 2120. For example, while operative use of the module installation tool 2100 can include moving the actuator 2180 such that the inner slider 2120 translates in unison with the actuator 2180, the magnetic coupling strength between the actuator 2180 and the inner slider 2120 can be sufficiently weak to restrict the inner slider 2120 from being overdriven by the actuator 2180.

As an example, the inner slider 2120 may position the tool head 2130 and/or the attached module in a position in which it is undesirable to translate the tool head 2130 and/or the module further in the proximal direction 2002. In such a configuration, urging the actuator 2180 further in the proximal direction 2002 with a force that exceeds a magnetic coupling force between the actuator 2180 and the inner slider 2120 can cause the actuator 2180 to become axially displaced from the inner slider 2120, thereby avoiding damage to components of the module installation tool 2100 that may occur if the inner slider 2120 were moved in unison with the actuator 2180. Unless otherwise indicated, however, descriptions herein of operations in which the actuator 2180 is axially translated may be understood as describing operations in which the inner slider 2120 is axially translated in an equivalent manner (e.g., at least substantially in unison with the actuator 2180).

Additionally, while the actuator 2180 and the inner slider 2120 may be configured to translate axially at least partially in unison with one another, the magnetic coupling mechanism 2190 may allow the actuator 2180 to rotate at least partially freely relative to the tool base 2110 and/or relative to the inner slider 2120. Such a configuration desirably may provide the user with a reassurance that the rotational orientation of the actuator 2180 need not be carefully controlled during use of the module installation tool 2100. This is not required, however, and it additionally is within the scope of the present disclosure that the actuator 2180 may be restricted from rotating relative to the inner slider 2120 (e.g., by the magnetic coupling mechanism 2190). For example, the magnetic coupling mechanism 2190 may be configured such that the magnetic field alternates around the central longitudinal axis to couple the rotational movement of the actuator 2180 and the inner slider 2120.

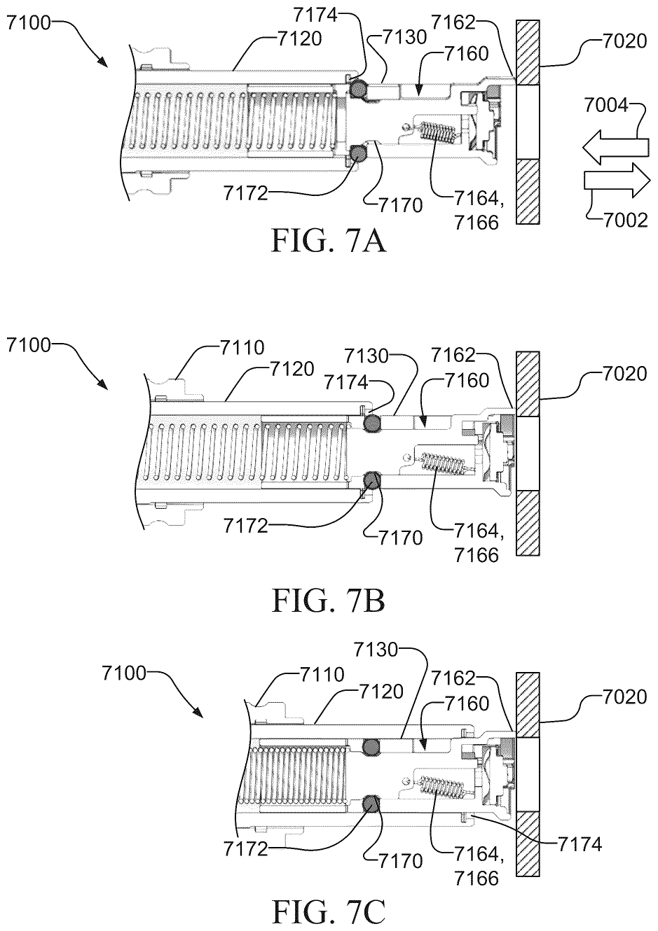

FIG. 2 additionally illustrates a manner in which the tool head 2130 is coupled to the inner slider 2120. As shown in FIG. 2, the tool head 2130 can extend at least partially within a slider inner cavity 2124 of the inner slider 2120. The module installation tool 2100 can include a tool head spring 2136 that biases the tool head 2130 in the proximal direction 2002 relative to the inner slider 2120 (or, equivalently, that biases the inner slider 2120 in the distal direction 2004 relative to the tool head 2130). As described in more detail below (e.g., with reference to FIGS. 7A-7C), the module installation tool 2100 can include a tool head interlock 2160 that selectively restricts the tool head 2130 from translating distally relative to the inner slider 2120 from the configuration shown in FIG. 2 (or, equivalently, that selectively restricts the inner slider 2120 from translating proximally relative to the tool head 2130).

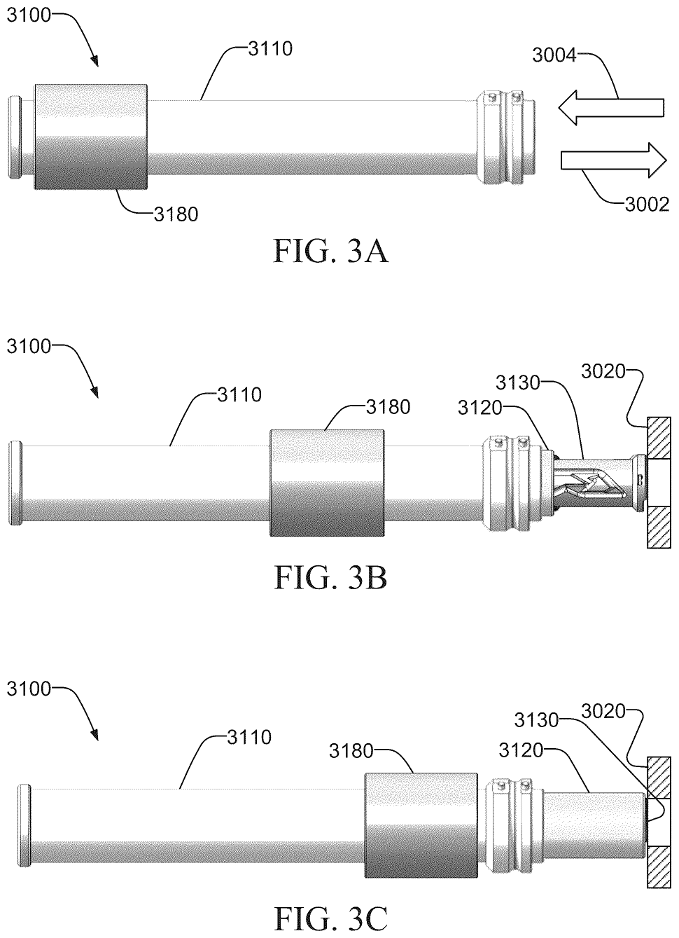

FIGS. 3A-3C depict an exemplary sequence of operations in which the actuator 3180 is translated relative to the tool base 3110 in the proximal direction 3002 (opposed to a distal direction 3004). Specifically, FIG. 3A illustrates a configuration in which the actuator 3180 is in a first actuator position, while FIG. 3B illustrates a configuration in which the actuator 3180 is in a second actuator position, and FIG. 3C illustrates a configuration in which the actuator 3180 is in a third actuator position.

When moving the actuator 3180 from the first actuator position of FIG. 3A to the second actuator position of FIG. 3B, the corresponding axial motion of the inner slider 3120 in the proximal direction 3002 can cause the tool head 3130 to translate relative to the tool base 3110 without rotating relative to the tool base 3110. When moving the actuator 3180 from the second actuator position of FIG. 3B to the third actuator position of FIG. 3C, however, the corresponding axial motion of the inner slider 3120 in the proximal direction 3002 can cause the tool head 3130 to rotate relative to the tool base 3110 without translating relative to the tool base 3110.

Specifically, in the example of FIGS. 3B-3C, the axial translation of the actuator 3180 from the second actuator position to the third actuator position is performed while the tool head 3130 is restricted from further translation in the proximal direction 3002, such as due to engagement with a module receiver 3020 configured to receive the module attached to the tool head 3130 (not shown in FIGS. 3A-3C). In such an example, translation of the actuator 3180 in the proximal direction 3002 from the second actuator position to the third actuator position can cause the inner slider 3120 to translate relative to the tool head 3130 in the proximal direction 3002 in a manner that causes rotation of the tool head 3130, as described in more detail below.

In some examples, after translating the actuator 3180 from the second actuator position to the third actuator position to rotate the tool head 3130, translating the actuator 3180 from the third actuator position back to the second actuator position causes further rotation of the tool head 3130 in the same direction. Stated differently, in some examples, moving the actuator 3180 from the second actuator position to the third actuator position causes the tool head 3130 to rotate relative to the tool base 3110 in a rotation direction, and subsequently moving the actuator 3180 from the third actuator position to the second actuator position causes the tool head 3130 to further rotate relative to the tool base 3110 in the same rotational direction.

In various examples, and as described in more detail below, the rotational direction in which the tool head 3130 rotates relative to the tool base 3110 is variable and depends upon an initial configuration of the tool head 3130 relative to the inner slider 3120.

The configurations of FIGS. 3A-3C also may be described with reference to axial positions of the tool head 3130 in each configuration. For example, when the actuator 3180 is in the first actuator position (FIG. 3A), the module installation tool 3100 may be described as being in a retracted configuration, and the tool head 3130 (not visible in FIG. 3A) may be described as being in a first axial position relative to the tool base 3110.

When the actuator 3180 is in the second actuator position (FIG. 3B), the module installation tool 3100 may be described as being in an extended configuration, and the tool head 3130 may be described as being in a second axial position relative to the tool base 3110. Translating the actuator 3180 from the second actuator position to the third actuator position (FIG. 3C) thus can operate to rotate the tool head 3130 relative to the tool base 3110 while the tool head 3130 remains in the second axial position.

In some examples, the configurations of each of FIGS. 3B and 3C may be described as representing the extended configuration of the module installation tool 3100. Stated differently, the extended configuration of the module installation tool 3100 can refer to an axial configuration of the tool head 3130 relative to the tool base 3110 independent of an axial position of the inner slider 3120 and/or of the actuator 3180.

FIGS. 4A-4B illustrate features of the tool head guide track 4140 of the tool head 4130. As shown in FIGS. 4A-4B, the tool head guide track 4140 can include a first terminal location 4142 and a second terminal location 4144 that are connected to one another via one or more paths, such as an installation path 4152 (indicated by solid arrows in FIG. 4A) and a removal path 4154 (indicated by solid arrows in FIG. 4B).

Each of FIGS. 4A-4B additionally represents an initial position of the tool head rotation driver 4150 along the tool head guide track 4140 in dashed lines. The tool head 4130 may be described as being in a first rotational orientation when the tool head rotation driver 4150 is positioned at the first terminal location 4142 and may be described as being in a second rotational orientation when the tool head rotation driver 4150 is positioned at the second terminal location 4144.

When the tool head rotation driver 4150 is positioned at the first terminal location 4142, the tool head 4130 may be described as being in a first initial configuration. Similarly, when the tool head rotation driver 4150 is positioned at the second terminal location 4144, the tool head 4130 may be described as being in a second initial configuration.

As described in more detail below, when the tool head is in the first initial configuration with the actuator in the second actuator position (e.g., FIG. 3B), moving the actuator from the second actuator position to the third actuator position (e.g., FIG. 3C) can cause the tool head to rotate relative to the tool base in an installation rotational direction (e.g., the installation rotational direction 1008 of FIG. 1) from the first rotational orientation to the second rotational orientation.

Similarly, when the tool head is in the second initial configuration with the actuator in the second actuator position, moving the actuator from the second actuator position to the third actuator position can cause the tool head to rotate relative to the tool base in a removal rotational direction (e.g., the removal rotational direction 1006 of FIG. 1) from the second rotational orientation to the first rotational orientation.

FIG. 4A illustrates the installation path 4152 connecting the first terminal location 4142 and the second terminal location 4144 such that driving the tool head rotation driver 4150 from the first terminal location 4142 to the second terminal location 4144 along the installation path 4152 causes the tool head 4130 to rotate in the installation rotational direction. In particular, with the tool head rotation driver 4150 initially positioned at the first terminal location 4142, moving the actuator in the proximal direction (e.g., from the second actuator position to the third actuator position) can cause the tool head rotation driver 4150 to travel through the installation path 4152 of the tool head guide track 4140 in the proximal direction until encountering an angled edge of the tool head guide track 4140.

Because the tool head rotation driver 4150 is constrained to travel along an axial direction (due to its fixed position relative to the rotationally constrained inner slider), urging the tool head rotation driver 4150 against an angled surface of the tool head 4130 (e.g., an angled edge of the tool head guide track 4140) causes the tool head 4130 to rotate about a central longitudinal axis thereof, such as in the installation rotational direction 1008 shown in FIG. 1.

As the tool head rotation driver 4150 is driven through the installation path 4152, the tool head rotation driver 4150 can reach an installation path intermediate location 4146, which represents the proximal-most location along the installation path 4152. With the tool head rotation driver 4150 positioned at the installation path intermediate location 4146, moving the actuator in the distal direction (e.g., from the third actuator position to the second actuator position) can cause the tool head rotation driver 4150 to travel distally through the tool head guide track 4140, such as under the bias of the tool head spring 2136 shown in FIG. 2. That is, with the tool head 4130 in a given axial position (e.g., the second axial position of FIGS. 3B-3C), moving the actuator in the distal direction can allow the tool head spring to move the inner slider in the distal direction relative to the tool head. This can cause the tool head rotation driver 4150 to travel though the installation path 4152 of the tool head guide track 4140 in the distal direction from the installation path intermediate location 4146 toward the second terminal location 4144. In this manner, the tool head spring may be described as biasing the tool head rotation driver 4150 toward and/or to the second terminal location 4144.

More specifically, in the example of FIG. 4A, moving the tool head rotation driver 4150 proximally from the first terminal location 4142 causes the tool head rotation driver 4150 to travel along a first installation path segment 4252 until encountering a first angled surface 4240. As the tool head rotation driver 4150 travels along a second installation path segment 4254 in engagement with the first angled surface 4240, the tool head rotation driver 4150 causes the tool head 4130 to rotate in the installation rotational direction. The tool head rotation driver 4150 then travels axially along a third installation path segment 4256 until encountering a second angled surface 4242. As the tool head rotation driver 4150 travels along a fourth installation path segment 4258 in engagement with the second angled surface 4242, the tool head rotation driver 4150 causes further rotation of the tool head 4130 in the installation rotational direction until the tool head rotation driver 4150 reaches the installation path intermediate location 4146. The tool head rotation driver 4150 then can travel distally from the installation path intermediate location 4146 along a fifth installation path segment 4260 until encountering a third angled surface 4244. As the tool head rotation driver 4150 travels along a sixth installation path segment 4262 in engagement with the third angled surface 4244, the tool head rotation driver 4150 can cause the tool head 4130 to rotate further in the installation rotational direction to reach the second rotational orientation. The tool head rotation driver 4150 then can travel axially along a seventh installation path segment 4264 to the second terminal location 4144.

FIG. 4B illustrates the removal path 4154 connecting the second terminal location 4144 and the first terminal location 4142 such that driving the tool head rotation driver 4150 from the second terminal location 4144 to the first terminal location 4142 along the removal path 4154 causes the tool head 4130 to rotate in the removal rotational direction. In particular, with the tool head rotation driver 4150 initially positioned at the second terminal location 4144, moving the actuator in the proximal direction (e.g., from the second actuator position to the third actuator position) can cause the tool head rotation driver 4150 to travel through the removal path 4154 of the tool head guide track 4140 in the proximal direction until encountering an angled edge of the tool head guide track 4140 to rotate the tool head 4130.

As the tool head rotation driver 4150 is driven through the removal path 4154, the tool head rotation driver 4150 can reach a removal path intermediate location 4148, which represents the proximal-most location along the removal path 4154. With the tool head rotation driver 4150 positioned at the removal path intermediate location 4148, moving the actuator in the distal direction (e.g., from the third actuator position to the second actuator position) can cause the tool head rotation driver 4150 to travel distally through the tool head guide track 4140, such as under the bias of the tool head spring 2136 shown in FIG. 2. This can cause the tool head rotation driver 4150 to travel though the removal path 4154 of the tool head guide track 4140 in the distal direction from the removal path intermediate location 4148 toward the first terminal location 4142. In this manner, the tool head spring may be described as biasing the tool head rotation driver 4150 toward and/or to the first terminal location 4142.

More specifically, in the example of FIG. 4A, moving the tool head rotation driver 4150 proximally from the second terminal location 4144 causes the tool head rotation driver 4150 to travel along a first removal path segment 4266 until encountering a fourth angled surface 4246. As the tool head rotation driver 4150 travels along a second removal path segment 4268, engagement between the tool head rotation driver 4150 and the fourth angled surface 4246 causes rotation of the tool head 4130 in the removal rotational direction from the second rotational orientation to the first rotational orientation. After reaching the removal path intermediate location 4148, the tool head rotation driver 4150 can travel distally along a third removal path segment 4270 until encountering a fifth angled surface 4248. Driving the tool head rotation driver 4150 along a fourth removal path segment 4272 in engagement with the fifth angled surface 4248 can cause the tool head 4130 to rotate in the installation rotational direction until the tool head rotation driver encounters a sixth angled surface 4250. Driving the tool head rotation driver 4150 along a fifth removal path segment 4274 in engagement with the sixth angled surface 4250 can cause the tool head 4130 to rotate back in the removal rotational direction to reach the first rotational orientation. The tool head rotation driver 4150 then can travel axially along a sixth removal path segment 4276 to the first terminal location 4142.

As shown in FIGS. 4A-4B, the tool head guide track 4140 additionally can include a bridge path 4156 that interconnects the installation path 4152 and the removal path 4154. In this manner, and as shown in dashed lines in FIG. 4A, the tool head rotation driver 4150 can travel from the first terminal location 4142 to the second terminal location 4144 via the bridge path 4156 rather than via the installation path 4152. Similarly, and as shown in dashed lines in FIG. 4B, the tool head rotation driver 4150 can travel from the second terminal location 4144 to the first terminal location 4142 via the bridge path 4156 rather than via the removal path 4154.

The bridge path 4156 thus may allow a user to transition the tool head 4130 between the first initial configuration and the second initial configuration without guiding the tool head rotation driver 4150 along the installation path 4152 or the removal path 4154, such as when the module installation tool is removed from the system to which the module is to be installed.

As shown in FIGS. 4A-4B, the bridge path 4156 can be spaced apart from (e.g., axially displaced from) the first terminal location 4142 and the second terminal location 4144, such as to restrict the tool head rotation driver 4150 from being inadvertently moved along the bridge path 4156.

In some examples, the tool head 4130, the inner slider (e.g., the inner slider 3120 of FIG. 3), and/or the tool base (e.g., the tool base 3110 of FIG. 3) can include alignment marks to help identify the first initial configuration and/or the second initial configuration.

FIGS. 4A-4B illustrate an example in which the removal path 4154 is partially different from the installation path 4152 and in which each of the installation path 4152 and the removal path 4154 is defined by static structures (namely, a channel formed in the tool head 4130). This is not required of all examples, however. For example, it also is within the scope of the present disclosure that the module installation tool can include a path selector such as a movable gate and/or a spring tab that changes a form of the tool head guide track 4140 to selectively guide the tool head rotation driver 4150 to follow the installation path 4152 or the removal path 4154. For example, the path selector can operate to act as a one-way escapement to dictate a direction of motion of the tool head rotation driver 4150.

The tool head guide track 4140 shown in FIGS. 4A-4B can be reproduced on an opposite side of the tool head 4130 (e.g., on a surface not visible in FIGS. 4A-4B), which in turn can be followed by a second tool head rotation driver of the module installation tool. In various examples, the tool head 4130 can include any suitable number of repeated instances of the tool head guide track 4140, which may be connected to one another and/or which may extend circumferentially (e.g., fully circumferentially) around the tool head 4130.

Additionally, or alternatively, in other examples, the tool head guide track 4140 and/or the tool head rotation driver 4150 can be configured such that the tool head 4130 rotates in the same rotational direction with each actuation by the user. For example, the module installation tool 5100 can be configured such that driving the actuator 4180 from the second actuator position to the third actuator position and back to the second actuator position causes the tool head 4130 to rotate in a given direction (e.g., the installation rotational direction or the removal rotational direction) independent of an initial position of the tool head rotation driver 4150 relative to the tool head guide track. In some such examples, the rotational direction can be toggled between the installation rotational direction and the removal rotational direction via a switch or other input actuated by the user.

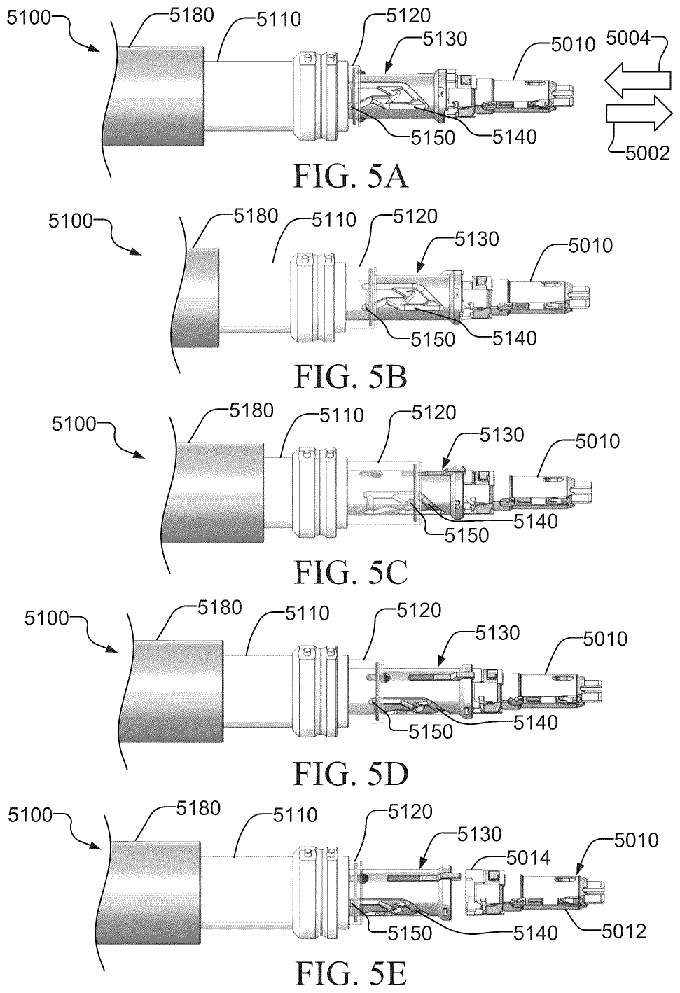

FIGS. 5A-5E illustrate a sequence of operations by which the module installation tool 5100 can install a module 5010 to a module receiver (not shown in FIGS. 5A-5E) via interaction between the tool head rotation driver 5150 and the tool head guide track 5140 of the tool head 5130. In particular, FIGS. 5A-5E illustrate a manner in which the tool head guide track 5140 can cause the inner slider 5120 to rotate the tool head 5130 in an installation rotational direction (e.g., the installation rotational direction 1008 of FIG. 1).

In the following description of FIGS. 5A-5E, reference is made to various portions of the tool head guide track 5140. For clarity, such portions may not be labeled in FIGS. 5A-5E, but it is to be understood that such portions correspond to the labeled portions of the tool head guide track 4140 of FIGS. 4A-4B. Additionally, in FIGS. 5A-5E, the inner slider 5120 is represented as being transparent for clarity.

In the example of FIGS. 5A-5E, the module 5010 includes a cartridge 5012 and a cartridge coupling clip 5014 rotatably coupled to the cartridge 5012 (as labeled in FIG. 5E). As illustrated, the tool head 5130 can be configured to engage the cartridge coupling clip 5014 to support the cartridge 5012 with the module installation tool 5100. The cartridge coupling clip 5014 also may be configured to be operatively coupled to the module receiver to operatively support the cartridge 5012 relative to the module receiver. In the example of FIGS. 5A-5E, the module 5010 includes and/or is an ion source, such as for a mass spectrometer system. In this manner, the module installation tool 5100 can be configured to install the ion source to the mass spectrometer system and/or to remove the ion source from the mass spectrometer system.

FIG. 5A illustrates a configuration in which the module 5010 is operatively coupled to the tool head 5130 and in which the actuator 5180 is being driven in the proximal direction 5002 to bring the module 5010 into engagement with the module receiver. In the configuration of FIG. 5A, the tool head rotation driver 5150 is in the first terminal location within the tool head guide track 5140 such that the tool head 5130 is in the first rotational orientation.

FIG. 5B illustrates a configuration in which the actuator 5180 is in the second actuator position such that the tool head 5130 has reached the second axial position. In the configuration of FIG. 5B, the tool head 5130 is restricted from further axial translation along the proximal direction 5002 due to engagement between the module 5010 and the module receiver.

As the actuator 5180 translates proximally from the configuration of FIG. 5B to the configuration of FIG. 5C, the tool head rotation driver 5150 moves along the installation path from the first terminal location to the installation path intermediate location. In the course of such motion, engagement between the tool head rotation driver 5150 and each of the first angled surface and the second angled surface of the tool head guide track 5140 causes the tool head 5130 to rotate in the installation rotational direction toward the second rotational orientation. In the configuration of FIG. 5C, the actuator 5180 is in the third actuator position and the tool head 5130 remains at the second axial position.

As the actuator 5180 is returned from the third actuator position of FIG. 5C to the second actuator position of FIG. 5D, the tool head rotation driver 5150 moves from the installation path intermediate location to the second terminal location. In the course of such motion, engagement between the tool head rotation driver 5150 and the third angled surface of the tool head guide track 5140 causes the tool head 5130 to rotate further in the installation rotational direction to the second rotational orientation. In the configuration of FIG. 5D, the tool head 5130 remains in engagement with the module 5010 but is uncoupled from the module 5010.

As the actuator 5180 is moved further in the distal direction 5004 from the configuration of FIG. 5D to the configuration of FIG. 5E, the inner slider 5120 and the tool head 5130 retract in unison, leaving the module 5010 operatively installed to the module receiver. Further translation of the actuator 5180 in the distal direction 5004 can cause the inner slider 5120 and the tool head 5130 to retract into the tool base 5110.

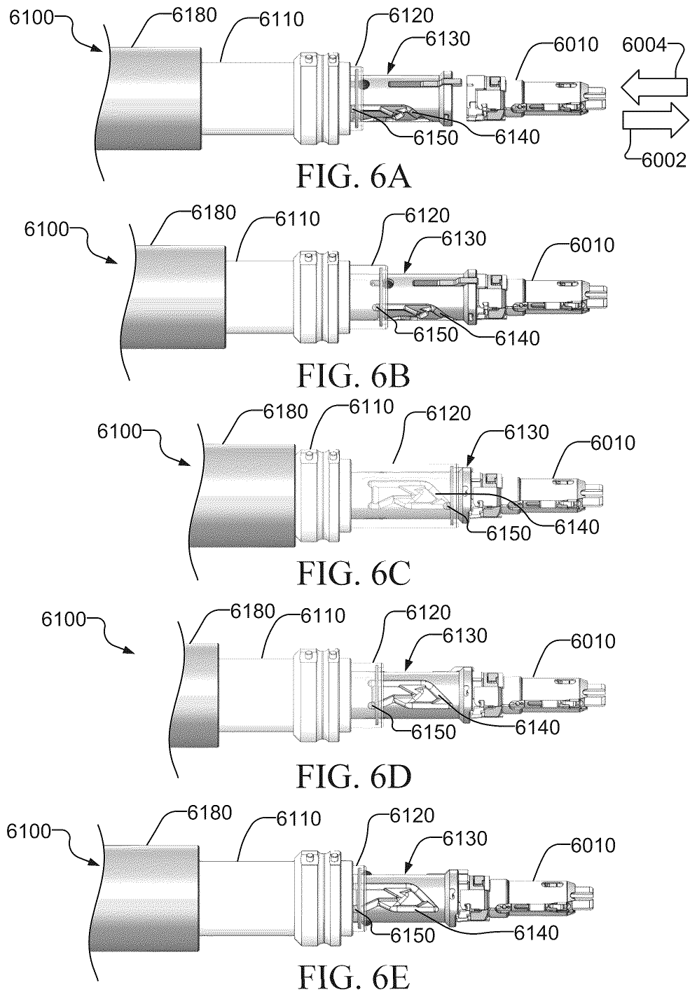

FIGS. 6A-6E illustrate a sequence of operations by which the module installation tool 6100 can remove a module 6010 from a module receiver (not shown in FIGS. 6A-6E) via interaction between the tool head rotation driver 6150 and the tool head guide track 6140 of the tool head 6130.

In the following description of FIGS. 6A-6E, reference is made to various portions of the tool head guide track 6140. For clarity, such portions may not be labeled in FIGS. 6A-6E, but it is to be understood that such portions correspond to the labeled portions of the tool head guide track 4140 of FIGS. 4A-4B. Additionally, in FIGS. 6A-6E, the inner slider 6120 is represented as being transparent for clarity.

FIG. 6A illustrates a configuration in which the module 6010 is operatively coupled to the module receiver and in which the actuator 6180 is being driven in the proximal direction 6002 to bring the tool head 6130 into engagement with the module 6010. In the configuration of FIG. 6A, the tool head rotation driver 6150 is in the second terminal location within the tool head guide track 6140 such that the tool head 6130 is in the second rotational orientation.

FIG. 6B illustrates a configuration in which the actuator 6180 is in the second actuator position such that the tool head 6130 has reached the second axial position. In the configuration of FIG. 6B, the tool head 6130 is restricted from further axial translation along the proximal direction 6002 due to engagement between the tool head 6130 and the module 6010, which in turn is axially constrained by the module receiver.

As the actuator 6180 translates proximally from the configuration of FIG. 6B to the configuration of FIG. 6C, the tool head rotation driver 6150 moves along the removal path from the second terminal location to the removal path intermediate location. In the course of such motion, engagement between the tool head rotation driver 6150 and the fourth angled surface of the tool head guide track 6140 causes the tool head 6130 to rotate in the removal rotational direction to the first rotational orientation. In the configuration of FIG. 6C, the actuator 6180 is in the third actuator position and the tool head 6130 remains at the second axial position.

As the actuator 6180 is returned from the third actuator position of FIG. 6C to the second actuator position of FIG. 6D, the tool head rotation driver 6150 moves from the removal path intermediate location to the first terminal location. In the course of such motion, engagement between the tool head rotation driver 6150 and the fifth angled surface of the tool head guide track 6140 rotates the tool head 6130 slightly in the installation direction, while subsequent engagement between the tool head rotation driver 6150 and the sixth angled surface rotates the tool head 6130 back in the removal direction to the first rotational orientation. In this manner, moving the tool head rotation driver 6150 from the removal intermediate location to the first terminal location results in no net rotation of the tool head 6130.

As a result of the rotation of the tool head 6130 relative to the module 6010, the tool head 6130 is operatively coupled to the module 6010 in the configuration of FIG. 6D, and the module 6010 is uncoupled from the module receiver.

As the actuator 6180 is moved further in the distal direction 6004 from the configuration of FIG. 6D to the configuration of FIG. 6E, the inner slider 6120, the tool head 6130, and the module 6010 retract in unison. Further translation of the actuator 6180 in the distal direction 6004 can cause the inner slider 6120, the tool head 6130, and the module 6010 to retract into the tool base 6110.

As discussed above in the context of FIG. 2, the module installation tool 2100 can include a tool head interlock 2160 that selectively restricts the inner slider 2120 from translating proximally relative to the tool head 2130. FIGS. 7A-7C illustrate the functionality of the tool head interlock 7160 in more detail.

The tool head interlock 7160 can beneficially restrict and/or prevent inadvertent rotation of the tool head 7130 when the tool head 7130 is not operatively positioned relative to the module receiver 7020. For example, when the tool head 7130 is not positioned relative to the module receiver 7020 in a proper position to receive or release the module, inadvertent rotation of the tool head 7130 can result in the module being misaligned relative to the module receiver 7020. Accordingly, the tool head interlock 7160 can operate to permit the inner slider 7120 to translate axially relative to the tool head 7130 only when the tool head 7130 is in a preferred position relative to the module receiver 7020.

The tool head interlock 7160 is configured to be transitioned between a locked configuration (FIG. 7A) and an unlocked configuration (FIGS. 7B-7C). When the tool head interlock 7160 is in the locked configuration, the inner slider 7120 is restricted from translating relative to the tool head 7130. When the tool head interlock 7160 is in the unlocked configuration, the inner slider 7120 is free to translate relative to the tool head 7130 (e.g., in the proximal direction 7002). The tool head interlock 7160 can be configured to transition from the locked configuration to the unlocked configuration when the module installation tool 7100 is in the extended configuration with the tool head interlock 7160 engaging the module receiver 7020.

FIG. 7A illustrates an example in which the module installation tool 7100 is in the extended configuration with a tool head interlock terminal end region 7162 of the tool head interlock 7160 abutting the module receiver 7020. In the example of FIG. 7A, the tool head interlock 7160 includes a tool head interlock biasing mechanism 7164 that biases the tool head interlock 7160 toward the locked configuration. Specifically, in the example of FIG. 7A, the tool head interlock biasing mechanism 7164 is a tool head interlock spring 7166 that biases the tool head interlock terminal end region 7162 in the proximal direction 7002 relative to the tool head 7130.

Additionally, in the example of FIG. 7A, the tool head interlock 7160 includes a pair of interlock bearing receivers 7170 (one of which is labeled in FIG. 7A), while the module installation tool 7100 includes a corresponding pair of tool head interlock bearings 7172 (one of which is illustrated in FIG. 7A). Each tool head interlock bearing 7172 can be restricted and/or prevented from moving axially relative to the tool head 7130 and/or may be captively supported by the tool head 7130.

When the tool head interlock 7160 is in the locked configuration, each tool head interlock bearing 7172 can extend at least partially radially exterior of the tool head 7130 to restrict, obstruct, and/or prevent axial motion of the inner slider 7120 relative to the tool head interlock bearings 7172. For example, in the configuration of FIG. 7A, each tool head interlock bearing 7172 obstructs axial translation of the inner slider 7120 in the proximal direction 7002. Accordingly, when the tool head interlock 7160 is in the locked configuration, axial translation of the inner slider 7120 in the proximal direction 7002 causes the tool head 7130 to move in unison with the inner slider 7120.

In some examples, and as shown in FIG. 7A, the inner slider 7210 can include a pair of slider bearing receivers 7174 (one of which is labeled in FIG. 7A) configured to at least partially receive the corresponding tool head interlock bearing 7172 when the tool head interlock 7160 is in the locked configuration. Each slider bearing receiver 7174 can be a recess, indentation, divot, etc. that is positioned at or near a slider proximal edge of the inner slider 7120 (e.g., the slider proximal edge 2126 shown in FIG. 2), and/or may be spaced apart from the slider proximal edge along the distal direction 7004.

As the module installation tool 7100 is translated further in the proximal direction 7002 from the configuration of FIG. 7A to the configuration of FIG. 7B, the module receiver 7020 can urge the tool head interlock terminal end region 7162 in the distal direction 7004 relative to the tool head 7130 from the perspective of the tool head 7130. From the perspective of the module receiver 7020, such motion may be described as the tool head interlock 7160 remaining fixed in position as the tool head 7130 is moved in the proximal direction 7002 relative to the tool head interlock 7160.

In the configuration of FIG. 7B, each interlock bearing receiver 7170 is aligned with the corresponding tool head interlock bearing 7172 such that each tool head interlock bearing 7172 may move radially inward to be at least partially received within the interlock bearing receiver 7170. FIG. 7B thus illustrates an example of the unlocked configuration of the tool head interlock 7160, in which each tool head interlock bearing 7172 is displaced radially inward with respect to the tool head 7130 and relative to the locked configuration to permit the inner slider 7210 to translate axially (e.g., in the proximal direction 7002) past the axial position of the tool head interlock bearings 7172.

With the tool head interlock bearings 7172 no longer obstructing axial motion of the inner slider 7120, the inner slider 7120 can be advanced proximally from the configuration of FIG. 7B to the configuration of FIG. 7C, which can result in rotation of the tool head 7130 relative to the inner slider 7120 as discussed above in the context of FIGS. 5A-6E. In this manner, FIG. 7B may correspond to a configuration in which the actuator is in the second actuator position, while FIG. 7C may correspond to a configuration in which the actuator is in the third actuator position. For clarity, FIGS. 7A-7C depict such a process from the perspective in which the tool head 7130 is rotationally fixed (e.g., from a perspective in which the inner slider 7120 rotates relative to the tool head 7130).

When transitioning from the locked configuration of FIG. 7A to the unlocked configuration of FIG. 7B, each tool head interlock bearing 7172 can be translated radially inward by a radial component of a force of the inner slider 7120 upon each tool head interlock bearing 7172. Similarly, when transitioning from the unlocked configuration of FIG. 7B to the locked configuration of FIG. 7A, each tool head interlock bearing 7172 can be translated radially outward by a radial component of a force exerted upon the tool head interlock bearing by a ramped surface of the corresponding interlock bearing receiver as the tool head interlock 7160 translates in the proximal direction 7002 relative to the tool head interlock bearings 7172. In other examples, each tool head interlock bearing 7172 can be biased radially inward or radially outward.

In various examples, the tool head 7130 and/or the tool head interlock 7160 can include any of a variety of additional or alternative structures and/or mechanisms to selectively restrict axial translation of the inner slider 7210 relative to the tool head 7130. As examples, the tool head interlock 7160 additionally or alternatively can include and/or be a lever arm, a cam, a pin, and/or another mechanism that interacts with a component associated with the module receiver to free the relative movement of the tool head 7130 and the inner sleeve 7120.

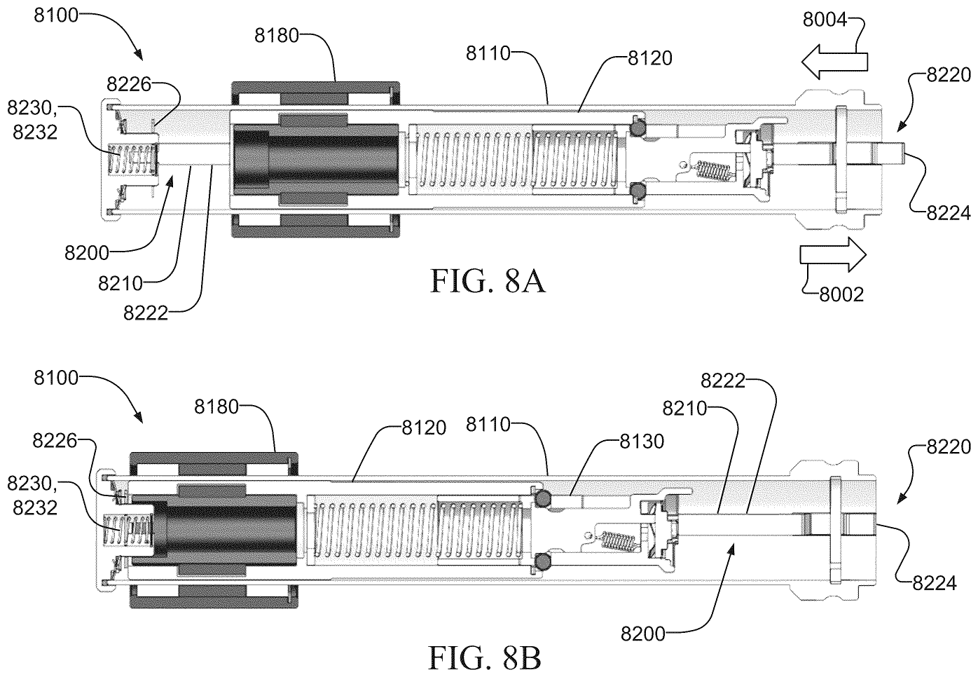

FIGS. 8A-8B are cross-sectional views of the module installation tool 8100 analogous to FIG. 2, with the actuator 8180 in various axial positions. As discussed above, the module installation tool 8100 may be used in conjunction with systems that operate under vacuum conditions while maintaining such systems under vacuum. Such systems thus may include a valve that isolates a region under vacuum when in a closed state and that permits the module installation tool 8100 to access the region under vacuum when in an open state.

In some examples, and as described below in the context of FIGS. 10A-10D, the module installation tool 8100 may be configured to extend through the valve when the valve is in the open state. In some such examples, it may be desirable to restrict the valve from transitioning from the open state to the closed state unless the module installation tool 8100 is removed from the valve. Accordingly, and as shown in FIGS. 8A-8B, the module installation tool 8100 can include a valve interlock 8220 that is configured to selectively restrict such a valve from transitioning from the open state to the closed state.

FIG. 8A illustrates the valve interlock 8220 in a locked configuration, while FIG. 8B illustrates the valve interlock 8220 in an unlocked configuration. In particular, in this example, the valve interlock 8220 includes a valve interlock body 8222 extending at least partially within the tool base 8110 and terminating in a valve interlock terminal end region 8224. As shown in FIG. 8A, the valve interlock terminal end region 8224 extends exterior of the tool base 8110 at least when the valve interlock 8220 is in the locked configuration. Transitioning the valve interlock 8220 from the locked configuration to the unlocked configuration can include translating the valve interlock body 8222 in the distal direction 8004 such that the valve interlock terminal end region 8224 is at least partially received within the tool base 8110 when the valve interlock 8220 is in the unlocked configuration.

As shown in FIG. 8A, the valve interlock 8220 can include a valve interlock biasing mechanism 8230 that biases the valve interlock 8220 toward the locked configuration.

The actuator 8180 can operate to transition the valve interlock 8220 to the unlocked configuration, such as via engagement between the inner slider 8120 and the valve interlock 8220. For example, and as shown in FIGS. 8A-8B, the valve interlock body 8222 can include a valve interlock plate 8226 positioned within the tool base 8110, and the valve interlock biasing mechanism 8230 can include and/or be a valve interlock spring 8232 that biases the valve interlock plate 8226 in the proximal direction 8002.

When the actuator 8180 is translated in the distal direction 8004 from the configuration of FIG. 8A to the configuration of FIG. 8B, the inner slider 8120 can engage the valve interlock plate 8226 to move the valve interlock body 8222 in the distal direction 8004, thereby moving the valve interlock terminal end region 8224 in the distal direction 8004.

As shown in FIGS. 8A-8B, the valve interlock 8220 may be described as representing a component of a slider position interlock 8200 that provides additional functionality. For example, the slider position interlock 8200 additionally can include and/or form a slider track 8210 (e.g., the slider track 2210 of FIG. 2) that restricts the inner slider 8120 from rotating relative to the tool base 8110. Such functionality may be understood with reference to FIG. 9, which illustrates the slider position interlock 9200 and the inner slider 9120 in isolation.

As shown in FIG. 9, the inner slider 9120 can include a track groove 9122 that at least partially receives the slider track 9210. In this manner. the inner slider 9120 may translate relative to the slider track 9210 in the proximal direction 9002 or in the distal direction 9004 while engagement between the slider track 9210 and the track groove 9122 can restrict the inner slider 9120 from rotating relative to the slider track 9210.

FIGS. 10A-10D schematically illustrate a sequence of events by which the module installation tool 10100 can be removed from an enclosure 10028 of a system, such as a mass spectrometer system. In this manner, FIGS. 10A-10D may be described as depicting an example in which the module installation tool 10100 removes a module 10010 in the form of an ion source from a mass spectrometer system that includes a valve 10024 positioned within an enclosure 10028. It is to be understood, however, that the operational principles depicted in FIGS. 10A-10D can be applied to any of a variety of systems.

FIG. 10A illustrates a configuration in which the module installation tool 10100 is operatively coupled to the enclosure 10028 with the tool base 10110 received within and coupled to a tool receiver 10022 that supports the module installation tool 10100 relative to the module receiver 10020. In the configuration of FIG. 10A, the module installation tool 10100 extends through a valve 10024 in an open state, and the valve interlock terminal end region 10224 of the valve interlock 10220 is received within an interlock receiver 10026 of the valve 10024.

While FIG. 10A illustrates an example in which the valve 10024 is a ball valve, it is to be understood that the operational principles depicted in FIGS. 10A-10D may be used in conjunction with any suitable valve type. Additionally (or alternatively), in some examples, the interlock receiver 10026 that receives the valve interlock terminal end region 10224 may be spaced apart from the valve 10024.

FIG. 10A may be described as representing a configuration analogous to that of FIG. 6E, with the tool head 10130 operatively coupled to the module 10010 and with the module 10010 uncoupled from the module receiver 10020. FIG. 10A thus may be described as representing a configuration in which the actuator 10180 is in the second actuator position.

In the configuration of FIG. 10A, the engagement of the valve interlock terminal end region 10224 with the interlock receiver 10026 can operate to restrict the valve 10024 from transitioning to the closed state, which could cause damage to the components of the module installation tool 10100 extending through the valve 10024.

FIG. 10B depicts a configuration in which the actuator 10180 has been translated in the distal direction 10004 to retract the inner slider 10120, the tool head 10130, and the module 10010 fully within the base inner cavity 10112 of the tool base 10110. In the configuration of FIG. 10B, the inner slider 10120 remains spaced apart from the valve interlock plate 10226 and the valve interlock terminal end region 10224 remains received within the interlock receiver 10026 to restrict the valve 10024 from transitioning to the closed state.

In the configuration of FIG. 10C, the actuator 10180 has been fully retracted to the first actuator position such that the inner slider 10120 has moved the valve interlock plate 10226 in the distal direction 10004 against the biasing force of the valve interlock biasing mechanism 10230. In this configuration, the valve interlock terminal end region 10224 is removed from the interlock receiver 10026 such that the valve interlock 10220 is in the unlocked configuration, thus permitting the valve 10024 to transition to the closed state depicted in FIG. 10D.

In this manner, the valve interlock 10220 can be configured such that actuation of the actuator 10180 to the first actuator position transitions the valve interlock to the unlocked configuration while the tool base 10110 remains operatively coupled to the tool receiver 10022. Thus, the valve interlock 10220 can ensure that the valve 10024 is closed only when components of the module installation tool 10100 are fully removed from the valve 10024 while also allowing the valve 10024 to close before removing the module installation tool 10100 from the enclosure 10028.

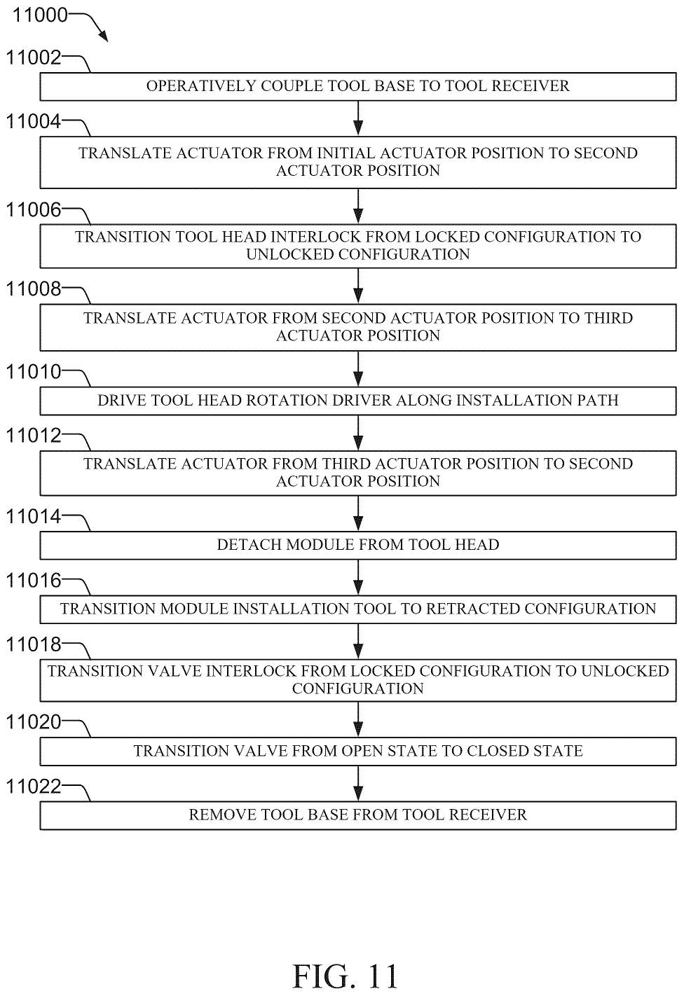

FIG. 11 is a flow chart depicting a method 11000 of installing a module to a module receiver with a module installation tool according to the present disclosure. In the following discussion, various components, configurations, and/or attributes are described in the context of the method 11000 with terms that correspond to components, configurations, and/or attributes illustrated in FIGS. 1-10D and/or discussed above. Such components, configurations, and/or attributes described herein with reference to the method 11000 thus may be understood as corresponding to and/or as representing the similarly named components, configurations, and/or attributes descried above with reference to FIGS. 1-10D unless otherwise specified.

As shown in FIG. 11, the method 11000 includes, with the module operatively coupled to a tool head of the module installation tool, translating, at 11004, an actuator of the module installation tool in a proximal direction from an initial actuator position to a second actuator position to bring the module into engagement with a module receiver. In the context of the method 11000, the initial actuator position can be, but is not required to be, the first actuator position described above. The method 11000 additionally includes translating, at 11008, the actuator in the proximal direction from the second actuator position to a third actuator position to rotate the tool head relative to the module receiver and subsequently detaching, at 11014, the module from the tool head.

In various examples, each of the translating the actuator from the initial actuator position to the second actuator position at 11004, the translating the actuator from the second actuator position to the third actuator position at 11008, and the detaching the module from the tool head at 11014 is performed while a tool base of the module installation tool is operatively coupled to a tool receiver that is fixed in position relative to the receiver.

In some examples, and as shown in FIG. 11, the method 11000 additionally includes, prior to the translating the actuator from the initial actuator position to the second actuator position at 11004, operatively coupling, at 11002, the tool base to the tool receiver. The operatively coupling the tool base to the tool receiver at 11002 can include coupling such that the tool base is axially fixed relative to the tool receiver and/or rotationally fixed relative to the tool receiver.

In some examples, and as shown in FIG. 11, the method 11000 additionally includes, subsequent to the detaching the module from the tool head at 11014, removing, at 11022, the tool base from the tool receiver. In some such examples, the method 11000 additionally includes, subsequent to the detaching the module from the tool head at 11014 and prior to the removing the tool base from the tool receiver at 11022, transitioning, at 11016, the module installation tool to a retracted configuration in which the tool head is at least partially received within the tool base. The transitioning the module installation tool to the retracted configuration at 11016 can be performed in any suitable manner, such as by translating the actuator in a distal direction.

In some examples, the module installation tool additionally includes a valve interlock configured to restrict transitioning a valve from an open state to a closed state while the valve interlock is in a locked configuration with the tool base operatively coupled to the tool receiver. In some such examples, the method 11000 additionally includes, prior to the removing the tool base from the tool receiver at 11022, transitioning, at 11020, the valve from the open state to the closed state. In some examples, the valve interlock can be transitioned, at 11018, from a locked configuration to an unlocked configuration.

The translating the actuator from the initial actuator position to the second actuator position at 11004 can be performed in any suitable manner. For example, the translating the actuator from the initial actuator position to the second actuator position at 11004 can include translating the actuator along a tool base of the module installation tool and/or can include translating the actuator without rotating the actuator.

The translating the actuator from the second actuator position to the third actuator position at 11008 can be performed in any suitable manner. For example, the translating the actuator from the second actuator position to the third actuator position at 11008 can include translating the actuator without rotating the actuator. In some examples, the translating the actuator from the second actuator position to the third actuator position at 11008 operates to rotate the tool head relative to the module receiver without translating the tool head relative to the module receiver.

In some examples, the method 11000 additionally includes, subsequent to the translating the actuator from the second actuator position to the third actuator position at 11008, translating, at 11012, the actuator from the third actuator position to the second actuator position. In some such examples, the translating the actuator from the third actuator position to the second actuator position at 11012 causes the tool head to rotate relative to the module receiver further in the installation rotational direction.

Additionally, or alternatively, the translating the actuator from the third actuator position to the second actuator position at 11012 can cause the tool head to be uncoupled from the module. In some examples, when the tool head is uncoupled from the module, the tool head may remain in contact with the module until the tool head is retracted away from the module.

The translating the actuator from the second actuator position to the third actuator position at 11008 and/or the translating the actuator from the third actuator position to the second actuator position at 11012 can cause the tool head to rotate relative to the module receiver in any suitable manner. In some examples, the translating the actuator from the second actuator position to the third actuator position at 11008 includes driving a tool head rotation driver at least partially along an installation path of a tool head guide track defined by the inner slider and/or the tool head to rotate the tool head relative to the inner slider. In some such examples, the tool head guide track includes a first terminal location and a second terminal location and the installation path interconnects the first terminal location and the second terminal location.

The translating the actuator from the second actuator position to the third actuator position at 11008 can include moving the tool head rotation driver from the first terminal location to an installation path intermediate location of the installation path. In some examples, the translating the actuator from the third actuator position to the second actuator position at 11012 causes the tool head rotation driver to move from the installation path intermediate location to the second terminal location to further rotate the tool head relative to the module in the installation direction. In various examples, the tool head rotation driver can be driven at 11010, along the installation path.

In some examples, and as shown in FIG. 11, the method 11000 additionally includes, prior to the translating the actuator from the second actuator position to the third actuator position at 11008, transitioning, at 11006, a tool head interlock of the module installation tool from a locked configuration to an unlocked configuration. Specifically, the transitioning the tool head interlock from the locked configuration to the unlocked configuration at 11006 can operate to permit motion of a portion of the module installation tool (e.g., the inner slider) relative to the tool head in the proximal direction.

In some examples, the transitioning the tool head interlock from the locked configuration to the unlocked configuration at 11006 includes urging the tool head interlock into engagement with the module receiver to translate the tool head in a proximal direction relative to the tool head interlock.

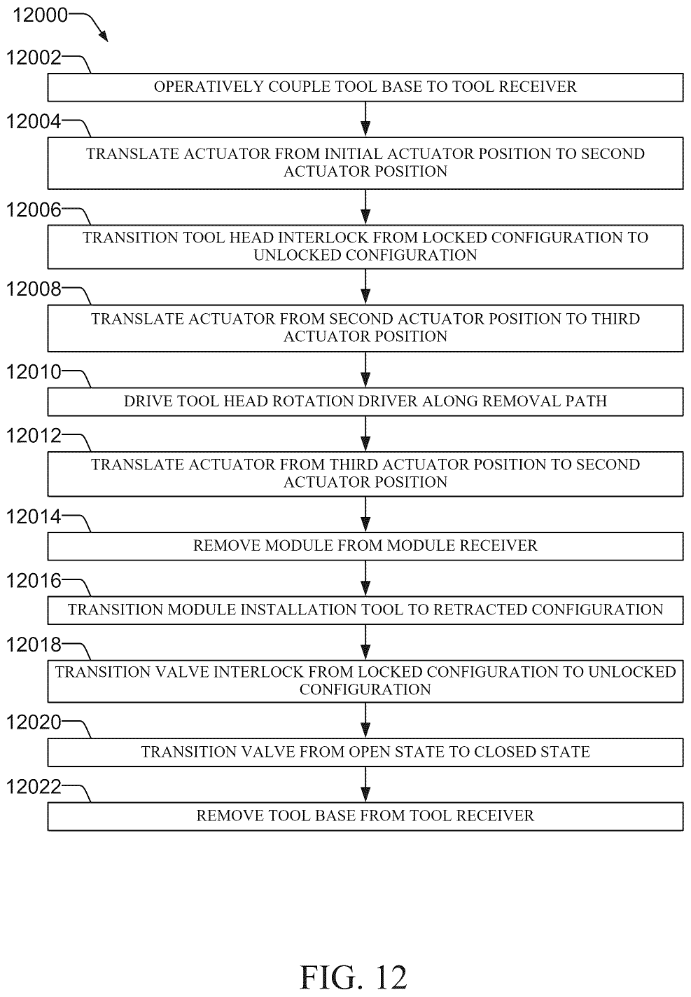

FIG. 12 is a flow chart depicting a method 12000 of removing a module from a module receiver with a module installation tool according to the present disclosure. In the following discussion, various components, configurations, and/or attributes are described in the context of the method 12000 with terms that correspond to components, configurations, and/or attributes illustrated in FIGS. 1-11 and/or discussed above. Such components, configurations, and/or attributes described herein with reference to the method 12000 thus may be understood as corresponding to and/or as representing the similarly named components, configurations, and/or attributes descried above with reference to FIGS. 1-11 unless otherwise specified.

As shown in FIG. 12, the method 12000 includes, with the module operatively coupled to a tool head of the module installation tool, translating, at 12004, an actuator of the module installation tool in a proximal direction from an initial actuator position to a second actuator position to bring a tool head of the module installation tool into engagement with a module that is operatively coupled to a module receiver. In the context of the method 12000, the initial actuator position can be, but is not required to be, the first actuator position described above. The method 12000 additionally includes translating, at 12008, the actuator in the proximal direction from the second actuator position to a third actuator position to rotate the tool head relative to the module receiver and subsequently removing, at 12014, the module from the module receiver.

In various examples, each of the translating the actuator from the initial actuator position to the second actuator position at 12004, the translating the actuator from the second actuator position to the third actuator position at 12008, and the removing the module from the module receiver at 12014 is performed while a tool base of the module installation tool is operatively coupled to a tool receiver that is fixed in position relative to the receiver.

In some examples, and as shown in FIG. 12, the method 12000 additionally includes, prior to the translating the actuator from the initial actuator position to the second actuator position at 12004, operatively coupling, at 12002, the tool base to the tool receiver. The operatively coupling the tool base to the tool receiver at 12002 can include coupling such that the tool base is axially fixed relative to the tool receiver and/or rotationally fixed relative to the tool receiver.

In some examples, and as shown in FIG. 12, the method 12000 additionally includes, subsequent to the removing the module from the module receiver at 12014, removing, at 12022, the tool base from the tool receiver. In some such examples, the method 12000 additionally includes, subsequent to the removing the module from the module receiver at 12014 and prior to the removing the tool base from the tool receiver at 12022, transitioning, at 12016, the module installation tool to a retracted configuration in which the tool head is at least partially received within the tool base. The transitioning the module installation tool to the retracted configuration at 12016 can be performed in any suitable manner, such as by translating the actuator in a distal direction.

In some examples, the module installation tool additionally includes a valve interlock configured to restrict transitioning a valve from an open state to a closed state while the valve interlock is in a locked configuration with the tool base operatively coupled to the tool receiver. In some such examples, the method 12000 additionally includes, prior to the removing the tool base from the tool receiver at 12022, transitioning, at 12020, the valve from the open state to the closed state. In some examples, the valve interlock can be transitioned, at 12018, from a locked configuration to an unlocked configuration.

The translating the actuator from the initial actuator position to the second actuator position at 12004 can be performed in any suitable manner. For example, the translating the actuator from the initial actuator position to the second actuator position at 12004 can include translating the actuator along a tool base of the module installation tool and/or can include translating the actuator without rotating the actuator.

The translating the actuator from the second actuator position to the third actuator position at 12008 can be performed in any suitable manner. For example, the translating the actuator from the second actuator position to the third actuator position at 12008 can include translating the actuator without rotating the actuator. In some examples, the translating the actuator from the second actuator position to the third actuator position at 12008 operates to rotate the tool head relative to the module receiver without translating the tool head relative to the module receiver.

In some examples, the method 12000 additionally includes, subsequent to the translating the actuator from the second actuator position to the third actuator position at 12008, translating, at 12012, the actuator from the third actuator position to the second actuator position. In some such examples, the translating the actuator from the third actuator position to the second actuator position at 12012 causes the tool head to rotate relative to the module receiver further in the removal rotational direction.

Additionally, or alternatively, the translating the actuator from the third actuator position to the second actuator position at 12012 can cause the module to be uncoupled from the module receiver. In some examples, when the module is uncoupled from the module receiver, the module may remain in contact with the module receiver until the tool head is retracted away from the module receiver.

The translating the actuator from the second actuator position to the third actuator position at 12008 and/or the translating the actuator from the third actuator position to the second actuator position at 12012 can cause the tool head to rotate relative to the module receiver in any suitable manner. In some examples, the translating the actuator from the second actuator position to the third actuator position at 12008 includes driving a tool head rotation driver at least partially along a removal path of a tool head guide track defined by the inner slider and/or the tool head to rotate the tool head relative to the inner slider. In some such examples, the tool head guide track includes a first terminal location and a second terminal location and the removal path interconnects the second terminal location and the first terminal location.

The translating the actuator from the second actuator position to the third actuator position at 12008 can include moving the tool head rotation driver from the second terminal location to a removal path intermediate location of the removal path. In some examples, the translating the actuator from the third actuator position to the second actuator position at 12012 causes the tool head rotation driver to move from the removal path intermediate location to the first terminal location to further rotate the tool head relative to the module in the removal direction.

In some examples, and as shown in FIG. 12, the method 12000 additionally includes, prior to the translating the actuator from the second actuator position to the third actuator position at 12008, transitioning, at 12006, a tool head interlock of the module installation tool from a locked configuration to an unlocked configuration. Specifically, the transitioning the tool head interlock from the locked configuration to the unlocked configuration at 12006 can operate to permit motion of a portion of the module installation tool (e.g., the inner slider) relative to the tool head in the proximal direction. In some examples, the transitioning the tool head interlock from the locked configuration to the unlocked configuration at 12006 includes urging the tool head interlock into engagement with the module receiver to translate the tool head in a proximal direction relative to the tool head interlock. In various examples, the tool head rotation driver can be driven at 12010, along the installation path.

### General Considerations

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

Unless otherwise stated, as used herein, the term “substantially” means the listed value and/or property and any value and/or property that is at least 75% of the listed value and/or property. Equivalently, the term “substantially” means the listed value and/or property and any value and/or property that differs from the listed value and/or property by at most 25%. For example, “substantially equal” refers to quantities that are fully equal, as well as to quantities that differ from one another by up to 25%.

The systems, apparatus, and methods described herein should not be construed as limiting in any way. Instead, the present disclosure is directed toward all novel and non-obvious features and aspects of the various disclosed examples, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, and the like may be characterized by qualifying terms such as “lowest,” “best,” “minimum,” “extreme,” etc. It is to be understood that such descriptions are intended to indicate that a selection among many used functional alternatives can be made, and such selections need not be better, smaller, or otherwise preferable to other selections.

### Additional Examples of the Disclosed Technology

Having described and illustrated the principles of the disclosed technology with reference to the illustrated examples, it will be recognized that the illustrated examples can be modified in arrangement and detail without departing from such principles. Also, the technologies from any example can be combined with the technologies described in any one or more of the other examples. It will be appreciated that procedures and functions such as those described with reference to the illustrated examples can be implemented in conjunction with any suitable apparatus and/or hardware, including apparatus and/or hardware not specifically disclosed and/or illustrated herein.

Example 1. An apparatus comprising: a tool head configured to engage and support a module that is configured to be selectively coupled to a module receiver; a tool base; and an actuator slidably coupled to the tool base, wherein the apparatus is configured such that axial motion of the actuator relative to the tool base causes the tool head to rotate relative to the tool base to couple the module to the module receiver or to uncouple the module from the module receiver.

Example 2. The apparatus of any example herein, particularly example 1, wherein the tool base is configured to be selectively coupled to a tool receiver that supports the apparatus relative to the module receiver.

Example 3. The apparatus of any example herein, particularly example 2, wherein the tool receiver is fixed in position relative to the module receiver.

Example 4. The apparatus of any example herein, particularly any one of examples 2-3, wherein the tool base comprises a tool receiver mating mechanism configured to selectively couple the tool base to the tool receiver.

Example 5. The apparatus of any example herein, particularly example 4, wherein the tool receiver mating mechanism comprises one or both of: (i) an alignment feature configured to rotationally align the tool base relative to the tool receiver; and (ii) a sealing surface configured to form an airtight seal against the tool receiver.

Example 6. The apparatus of any example herein, particularly any one of examples 2-5, wherein the apparatus is configured to extend through a valve in an open state when the tool base is coupled to the tool receiver.

Example 7. The apparatus of any example herein, particularly example 6, further comprising a valve interlock configured to selectively restrict the valve from transitioning from the open state to a closed state.

Example 8. The apparatus of any example herein, particularly example 7, wherein the valve interlock is configured to transition between a locked configuration and an unlocked configuration, and wherein the actuator is configured to transition the valve interlock to the unlocked configuration while the tool base is operatively coupled to the tool receiver.

Example 9. The apparatus of any example herein, particularly example 8, wherein the valve interlock comprising a valve interlock biasing mechanism that biases the valve interlock toward the locked configuration.

Example 10. The apparatus of any example herein, particularly example 9, wherein the valve interlock biasing mechanism comprises a valve interlock spring that is depressed by an inner slider of the apparatus when the apparatus is in a retracted configuration.

Example 11. The apparatus of any example herein, particularly any one of examples 8-10, wherein the tool base translates in a proximal direction relative to the valve interlock to transition from the locked configuration to the unlocked configuration.

Example 12. The apparatus of any example herein, particularly any one of examples 8-11, wherein the valve interlock comprises a valve interlock body extending at least partially within the tool base and terminating in a valve interlock terminal end region that extends exterior of the tool base at least when the valve interlock is in the locked configuration.

Example 13. The apparatus of any example herein, particularly example 12, wherein the valve interlock terminal end region is at least partially received within the tool base when the valve interlock is in the unlocked configuration.

Example 14. The apparatus of any example herein, particularly any one of examples 12-13, wherein the valve interlock body comprises a valve interlock plate positioned within the tool base, and wherein the apparatus comprises an inner slider that is configured to engage the valve interlock plate to transition the valve interlock from the locked configuration to the unlocked configuration.

Example 15. The apparatus of any example herein, particularly any one of examples 7-14, further comprising a slider position interlock that comprises the valve interlock.

Example 16. The apparatus of any example herein, particularly any one of examples 1-15, wherein moving the actuator from a first actuator position to a second actuator position causes the tool head to translate relative to the tool base without rotating relative to the tool base.

Example 17. The apparatus of any example herein, particularly example 16, wherein moving the actuator from the second actuator position to a third actuator position causes the tool head to rotate relative to the tool base without translating relative to the tool base.

Example 18. The apparatus of any example herein, particularly example 17, wherein the second actuator position is positioned between the first actuator position and the third actuator position.

Example 19. The apparatus of any example herein, particularly any one of examples 17-18, wherein moving the actuator from the second actuator position to the third actuator position causes the tool head to rotate relative to the tool base in a rotational direction, and wherein subsequently moving the actuator from the third actuator position to the second actuator position causes the tool head to further rotate relative to the tool base in the same rotational direction.

Example 20. The apparatus of any example herein, particularly any one of examples 17-19, wherein the tool head is configured to be transitioned among a plurality of configurations including a first initial configuration and a second initial configuration, wherein, when the tool head is in the first initial configuration with the actuator in the second actuator position, moving the actuator from the second actuator position to the third actuator position causes the tool head to rotate relative to the tool base in an installation rotational direction, and wherein, when the tool head is in the second initial configuration with the actuator in the second actuator position, moving the actuator from the second actuator position to the third actuator position causes the tool head to rotate relative to the tool base in a removal rotational direction opposite to the installation rotational direction.

Example 21. The apparatus of any example herein, particularly example 20, wherein, when the tool head is in the first initial configuration with the actuator in the second actuator position, moving the actuator from the second actuator position to the third actuator position and subsequently back to the second actuator position causes the tool head to rotate relative to the tool base in the installation rotational direction as the actuator moves from the third actuator position to the second actuator position.

Example 22. The apparatus of any example herein, particularly any one of examples 20-21, wherein, when the tool head is in the second initial configuration with the actuator in the second actuator position, moving the actuator from the second actuator position to the third actuator position and subsequently back to the second actuator position causes the tool head to rotate relative to the tool base in the removal rotational direction as the actuator moves from the third actuator position to the second actuator position.

Example 23. The apparatus of any example herein, particularly any one of examples 1-22, wherein the apparatus is configured such that moving the actuator axially relative to the tool base transitions the apparatus among a plurality of configurations defined between and including a retracted configuration, in which the tool head is in a first axial position relative to the tool base, and an extended configuration, in which the tool head is in a second axial position relative to the tool base that is displaced from the first axial position along a proximal direction, and wherein the apparatus is configured to rotate the tool head relative to the tool base while the tool head remains in the second axial position.

Example 24. The apparatus of any example herein, particularly any one of examples 1-23, wherein the actuator is in a first actuator position relative to the tool base when the apparatus is in the retracted configuration, wherein the actuator is in a second actuator position relative to the tool base when the apparatus is in the extended configuration, and wherein moving the actuator from the second actuator position to a third actuator position relative to the tool base causes the tool head to rotate relative tool base while the tool head remains in the second axial position.

Example 25. The apparatus of any example herein, particularly any one of examples 1-24, further comprising an inner slider configured to translate relative to each of the tool base and the tool head, wherein axial translation of the inner slider relative to the tool head causes rotation of the tool head relative to the tool base.

Example 26. The apparatus of any example herein, particularly example 25, wherein the inner slider is at least partially received within the tool base.

Example 27. The apparatus of any example herein, particularly any one of examples 25-26, wherein moving the actuator relative to the tool base causes the inner slider to translate relative to the tool base.

Example 28. The apparatus of any example herein, particularly any one of examples 25-27, wherein the tool base extends between the actuator and the inner slider.

Example 29. The apparatus of any example herein, particularly any one of examples 25-28, further comprising: a tool head guide track defined by one or both of the inner slider and the tool head; and a tool head rotation driver fixed in position relative to one of the inner slider or the tool head, and wherein translating the inner slider relative to the tool head causes the tool head rotation driver to travel along the tool head guide track to rotate the tool head relative to the tool base.

Example 30. The apparatus of any example herein, particularly example 29, wherein the tool head guide track comprises a channel formed in the tool head, and wherein the tool head rotation driver comprises a ball bearing that travels along a path defined by the channel as the inner slider moves relative to the tool head.

Example 31. The apparatus of any example herein, particularly any one of examples 29-30, wherein the tool head guide track comprises: a first terminal location; a second terminal location; an installation path connecting the first terminal location and the second terminal location; and a removal path connecting the first terminal location and the second terminal location, wherein the apparatus is configured such that the tool head rotates relative to the tool base in an installation rotational direction as the tool head rotation driver moves from the first terminal location to the second terminal location along the installation path, and wherein the apparatus is configured such that that the tool head rotates relative to the tool base in a removal rotational direction opposite to the installation rotational direction when the tool head rotation driver moves from the second terminal location to the first terminal location via the removal path.

Example 32. The apparatus of any example herein, particularly example 31, wherein the removal path is at least partially different from the installation path.

Example 33. The apparatus of any example herein, particularly any one of examples 31-32, wherein, when the tool head rotation driver is at the first terminal location, moving the inner slider relative to the tool head with the actuator causes the tool head rotation driver to follow the installation path to the second terminal location, and wherein, when the tool head rotation driver is at the second terminal location, moving the inner slider relative to the tool head with the actuator causes the tool head rotation driver to follow the removal path to the first terminal location.

Example 34. The apparatus of any example herein, particularly any one of examples 31-33, wherein the installation path comprises an installation path intermediate location that is a proximal-most location along the installation path, wherein moving the inner slider relative to the tool head to move the tool head rotation driver from the first terminal location to the installation path intermediate location rotates the tool head in the installation rotational direction, and wherein moving the inner slider relative to the tool head to move the tool head rotation driver from the installation path intermediate location to the second terminal location rotates the tool head further in the installation rotational direction.

Example 35. The apparatus of any example herein, particularly example 34, further comprising a tool head spring that biases the inner slider in a distal direction relative to the tool head, wherein the tool head spring is configured to move the inner slider in the distal direction relative to the tool head to move the tool head rotation driver from the installation path intermediate location toward the second terminal location.

Example 36. The apparatus of any example herein, particularly any one of examples 31-35, wherein the removal path comprises a removal path intermediate location that is a proximal-most location along the removal path, wherein moving the inner slider relative to the tool head to move the tool head rotation driver from the second terminal location to the removal path intermediate location rotates the tool head in the removal rotational direction, and wherein moving the inner slider relative to the tool head to move the tool head rotation driver from the removal path intermediate location to the first terminal location rotates the tool head further in the removal rotational direction.

Example 37. The apparatus of any example herein, particularly example 36, further comprising a tool head spring that biases the inner slider in a distal direction relative to the tool head, wherein the tool head spring is configured to move the inner slider in the distal direction relative to the tool head to move the tool head rotation driver from the removal path intermediate location toward the first terminal location.

Example 38. The apparatus of any example herein, particularly any one of examples 31-37, wherein the tool head guide track further comprises a bridge path that interconnects the installation path and the removal path.

Example 39. The apparatus of any example herein, particularly example 38, wherein the bridge path is spaced apart from one or both of the first terminal location and the second terminal location.

Example 40. The apparatus of any example herein, particularly any one of examples 31-39, wherein the installation path and the removal path are defined by static structures.

Example 41. The apparatus of any example herein, particularly any one of examples 31-40, further comprising a path selector that changes a form of the tool head guide track to selectively guide the tool head rotation driver to follow the installation path or the removal path.

Example 42. The apparatus of any example herein, particularly any one of examples 29-41, wherein the tool head rotation driver is fixedly coupled to one of the inner slider or the tool head.

Example 43. The apparatus of any example herein, particularly any one of examples 29-42, wherein the tool head rotation driver is captively supported by one of the inner slider or the tool head.

Example 44. The apparatus of any example herein, particularly any one of examples 29-43, wherein the tool head rotation driver comprises a ball bearing.

Example 45. The apparatus of any example herein, particularly any one of examples 29-44, wherein the tool head rotation driver comprises a pin.

Example 46. The apparatus of any example herein, particularly any one of examples 25-45, further comprising a tool head interlock that selectively restricts the inner slider from translating relative to the tool head.

Example 47. The apparatus of any example herein, particularly example 46, wherein the tool head interlock is configured to be transitioned between a locked configuration, in which the inner slider is restricted from translating relative to the tool head, and an unlocked configuration, in which the inner slider is free to translate relative to the tool head.

Example 48. The apparatus of any example herein, particularly example 47, wherein the tool head interlock is configured to transition to the unlocked configuration when the apparatus is in an extended configuration with the tool head interlock engaging the module receiver.

Example 49. The apparatus of any example herein, particularly any one of examples 47-48, wherein the tool head interlock comprises a tool head interlock terminal end region configured to engage a portion of the module receiver, and wherein, when the tool head is driven toward the module receiver, the module receiver urges the tool head interlock terminal end region in a distal direction relative to the tool head to transition the tool head interlock from the locked configuration to the unlocked configuration.

Example 50. The apparatus of any example herein, particularly any one of examples 47-49, wherein the tool head interlock comprises a tool head interlock biasing mechanism that biases the tool head interlock toward the locked configuration.

Example 51. The apparatus of any example herein, particularly example 50, wherein the tool head interlock biasing mechanism comprises a tool head interlock spring that biases a tool head interlock terminal end region of the tool head interlock in a proximal direction relative to the tool head.

Example 52. The apparatus of any example herein, particularly any one of examples 47-51, wherein the tool head interlock comprises an interlock bearing receiver, and wherein the apparatus further comprises a tool head interlock bearing that is at least partially received within the interlock bearing receiver when the tool head interlock is in the unlocked configuration.

Example 53. The apparatus of any example herein, particularly example 52, wherein the tool head interlock bearing is restricted from moving axially relative to the tool head, wherein, when the tool head interlock is in the locked configuration, the tool head interlock bearing extends at least partially radially exterior of the tool head to restrict axial motion of the inner slider relative to the tool head interlock bearing, and wherein, when the tool head interlock is in the unlocked configuration, the tool head interlock bearing is displaced radially inward with respect to the tool head relative to the locked configuration to permit the inner slider to translate axially past the position of the tool head interlock bearing.

Example 54. The apparatus of any example herein, particularly any one of examples 47-53, wherein the actuator is configured to translate in a proximal direction from a first actuator position to a second actuator position to transition the apparatus from a retracted configuration, in which the tool head is in a first axial position relative to the tool base, and an extended configuration, in which the tool head is in a second axial position relative to the tool base that is displaced from the first axial position along the proximal direction, and wherein the tool head interlock is configured to transition to the unlocked configuration when the apparatus is in the extended configuration with the tool head interlock engaging the module receiver.

Example 55. The apparatus of any example herein, particularly example 54, wherein the actuator is in the first actuator position relative to the tool base when the apparatus is in the retracted configuration, wherein the actuator is in the second actuator position relative to the tool base when the apparatus is in the extended configuration, and wherein moving the actuator from the second actuator position to a third actuator position relative to the tool base causes the tool head to rotate relative tool base while the tool head remains in the second axial position.

Example 56. The apparatus of any example herein, particularly any one of examples 25-55, wherein the actuator and the inner slider are coupled to one another via a non-contact coupling.

Example 57. The apparatus of any example herein, particularly any one of examples 25-56, further comprising a magnetic coupling mechanism that magnetically couples the actuator and the inner slider to one another.

Example 58. The apparatus of any example herein, particularly example 57, wherein the magnetic coupling mechanism comprises an actuator magnet fixedly coupled to the actuator and an inner slider magnet fixedly coupled to the inner slider.

Example 59. The apparatus of any example herein, particularly any one of examples 57-58, wherein the actuator comprises a magnetic shield that at least partially shields a region exterior of the actuator from magnetic fields produced by the magnetic coupling mechanism.

Example 60. The apparatus of any example herein, particularly example 59, wherein the actuator comprises an outer sleeve configured to be gripped by a user, and wherein the outer sleeve comprises the magnetic shield.

Example 61. The apparatus of any example herein, particularly any one of examples 57-60, wherein the magnetic coupling mechanism restricts the actuator from rotating relative to the inner slider.

Example 62. The apparatus of any example herein, particularly any one of examples 25-61, wherein the inner slider is restricted from rotating relative to the tool base.

Example 63. The apparatus of any example herein, particularly any one of examples 25-62, further comprising a slider track that engages the inner slider to restrict the inner slider from rotating relative to the tool base.

Example 64. The apparatus of any example herein, particularly example 63, wherein the slider track is rotationally fixed relative to the tool base.

Example 65. The apparatus of any example herein, particularly any one of examples 63-64, wherein the slider track extends longitudinally within the tool base, and wherein the inner slider comprises a track groove that receives the slider track such that the inner slider may translate relative to the slider track.

Example 66. The apparatus of any example herein, particularly any one of examples 63-65, further comprising a slider position interlock that comprises the slider track.

Example 67. The apparatus of any example herein, particularly any one of examples 1-66, wherein the tool base comprises a base inner cavity, and wherein, when the apparatus is in the retracted configuration, the tool head is at least partially received, and optionally fully received, within the base inner cavity.

Example 68. The apparatus of any example herein, particularly any one of examples 1-67, wherein the tool base comprises a base inner cavity, and wherein, when the module is operatively coupled to the tool head and the apparatus is in the retracted configuration, the module is at least partially received, and optionally fully received, within the base inner cavity.

Example 69. The apparatus of any example herein, particularly any one of examples 1-68, further comprising the module.

Example 70. The apparatus of any example herein, particularly any one of examples 1-69, wherein the module comprises an ion source.

Example 71. The apparatus of any example herein, particularly any one of examples 1-70, wherein the module comprises a cartridge and a cartridge coupling clip rotatably coupled to the cartridge, wherein the tool head is configured to engage the cartridge coupling clip to support the cartridge with the apparatus.

Example 72. The apparatus of any example herein, particularly any one of examples 1-71, wherein the module receiver is comprised in a mass spectrometer system, and wherein the apparatus is configured to install the module to the mass spectrometer system and to remove the module from the mass spectrometer system.

Example 73. A method comprising: with a module operatively coupled to a tool head of a module installation tool, translating an actuator of the module installation tool in a proximal direction from an initial actuator position to a second actuator position to bring the module into engagement with a module receiver; translating the actuator in the proximal direction from the second actuator position to a third actuator position to rotate the tool head relative to the module receiver in an installation rotational direction to at least partially couple the module to the module receiver; and detaching the module from the tool head.

Example 74. The method of any example herein, particularly example 73, wherein the module installation tool comprises a tool base that supports the tool head, and wherein each of the translating the actuator from the initial actuator position to the second actuator position, the translating the actuator from the second actuator position to the third actuator position, and the detaching the module from the tool head is performed while the tool base is operatively coupled to a tool receiver that is fixed in position relative to the module receiver.

Example 75. The method of any example herein, particularly example 74, further comprising, prior to the translating the actuator from the initial actuator position to the second actuator position, operatively coupling the tool base to the tool receiver.

Example 76. The method of any example herein, particularly example 75, wherein the operatively coupling the tool base to the tool receiver comprises coupling such that the tool base is one or both of axially fixed relative to the tool receiver and rotationally fixed relative to the tool receiver.

Example 77. The method of any example herein, particularly any one of examples 73-76, further comprising, subsequent to the detaching the module from the tool head, removing the tool base from the tool receiver.

Example 78. The method of any example herein, particularly example 77, further comprising, subsequent to the detaching the module from the tool head and prior to the removing the tool base from the tool receiver, transitioning the module installation tool to a retracted configuration in which the tool head is at least partially received within the tool base.

Example 79. The method of any example herein, particularly example 78, wherein the transitioning the module installation tool to the retracted configuration comprises translating the actuator in a distal direction opposite to the proximal direction.

Example 80. The method of any example herein, particularly any one of examples 78-79, wherein the module installation tool further comprises a valve interlock configured to restrict transitioning a valve from an open state to a closed state while the valve interlock is in an locked configuration with the tool base operatively coupled to the tool receiver, and wherein the transitioning the module installation tool to the retracted configuration comprises transitioning the valve interlock from the locked configuration to an unlocked configuration to permit the valve to transition to the closed state.

Example 81. The method of any example herein, particularly example 80, further comprising, prior to the removing the tool base from the tool receiver, transitioning the valve from the open state to the closed state.

Example 82. The method of any example herein, particularly any one of examples 73-81, wherein the translating the actuator from the initial actuator position to the second actuator position comprises translating the actuator along a tool base of the module installation tool.

Example 83. The method of any example herein, particularly any one of examples 73-82, wherein the translating the actuator from the initial actuator position to the second actuator position comprises translating the actuator without rotating the actuator.

Example 84. The method of any example herein, particularly any one of examples 73-83, wherein the translating the actuator from the second actuator position to the third actuator position comprises translating the actuator without rotating the actuator.

Example 85. The method of any example herein, particularly any one of examples 73-84, wherein the translating the actuator from the second actuator position to the third actuator position operates to rotate the tool head relative to the module receiver without translating the tool head relative to the module receiver.

Example 86. The method of any example herein, particularly any one of examples 73-85, wherein the module installation tool comprises: an inner slider configured to translate axially relative to the tool head; a tool head guide track defined by one or both of the inner slider and the tool head; and a tool head rotation driver fixed in position relative to one of the inner slider or the tool head, and wherein the translating the actuator from the second actuator position to the third actuator position comprises driving the tool head rotation driver at least partially along an installation path of the tool head guide track to rotate the tool head relative to the inner slider.

Example 87. The method of any example herein, particularly example 86, wherein the tool head guide track comprises a first terminal location and a second terminal location, wherein the installation path interconnects the first terminal location and the second terminal location, wherein the translating the actuator from the second actuator position to the third actuator position comprises moving the tool head rotation driver from the first terminal location to an installation path intermediate location of the installation path, and wherein the method further comprises translating the actuator from the third actuator position to the second actuator position to move the tool head rotation driver from the installation path intermediate location to the second terminal location to further rotate the tool head relative to the module in the installation rotational direction.

Example 88. The method of any example herein, particularly example 87, further comprising, subsequent to the translating the actuator from the second actuator position to the third actuator position, translating the actuator from the third actuator position to the second actuator position.

Example 89. The method of any example herein, particularly example 88, wherein the translating the actuator from the third actuator position to the second actuator position causes the tool head to rotate relative to the module receiver further in the installation rotational direction.

Example 90. The method of any example herein, particularly any one of examples 88-89, wherein the translating the actuator from the third actuator position to the second actuator position causes the tool head to be uncoupled from the module.

Example 91. The method of any example herein, particularly any one of examples 73-90, further comprising, prior to the translating the actuator to the third actuator position, transitioning a tool head interlock of the module installation tool from a locked configuration to an unlocked configuration to permit motion of a portion of the module installation tool relative to the tool head in the proximal direction.

Example 92. The method of any example herein, particularly example 91, wherein the transitioning the tool head interlock from the locked configuration to the unlocked configuration comprises urging the tool head interlock into engagement with the module receiver to translate the tool head in a proximal direction relative to the tool head interlock.

Example 93. A method comprising: translating an actuator of a module installation tool in a proximal direction from an initial actuator position to a second actuator position to bring a tool head of the module installation tool into engagement with a module that is operatively coupled to a module receiver; translating the actuator in the proximal direction from the second actuator position to a third actuator position to rotate the tool head relative to the module in a removal rotational direction to at least partially couple the module to the tool head; and removing the module from the module receiver.

Example 94. The method of any example herein, particularly example 93, wherein the module installation tool comprises a tool base that supports the tool head, and wherein each of the translating the actuator from the initial actuator position to the second actuator position, the translating the actuator from the second actuator position to the third actuator position, and the removing the module from the module receiver is performed while the tool base is operatively coupled to a tool receiver that is fixed in position relative to the module receiver.

Example 95. The method of any example herein, particularly example 94, further comprising, prior to the translating the actuator from the initial actuator position to the second actuator position, operatively coupling the tool base to the tool receiver.

Example 96. The method of any example herein, particularly example 95, wherein the operatively coupling the tool base to the tool receiver comprises coupling such that the tool base is one or both of axially fixed relative to the tool receiver and rotationally fixed relative to the tool receiver.

Example 97. The method of any example herein, particularly any one of examples 93-96, further comprising, subsequent to the removing the module from the module receiver, removing the tool base from the tool receiver.

Example 98. The method of any example herein, particularly example 97, further comprising, subsequent to the removing the module from the module receiver and prior to the removing the tool base from the tool receiver, transitioning the module installation tool to a retracted configuration in which the module is at least partially received within the tool base.

Example 99. The method of any example herein, particularly example 98, wherein the transitioning the module installation tool to the retracted configuration comprises translating the actuator in a distal direction opposite to the proximal direction.

Example 100. The method of any example herein, particularly any one of examples 98-99, wherein the module installation tool further comprises a valve interlock configured to restrict transitioning a valve from an open state to a closed state while the valve interlock is in a locked configuration with the tool base operatively coupled to the tool receiver, and wherein the transitioning the module installation tool to the retracted configuration comprises transitioning the valve interlock from the locked configuration to an unlocked configuration to permit the valve to transition to the closed state.

Example 101. The method of any example herein, particularly example 100, further comprising, prior to the removing the tool base from the tool receiver, transitioning the valve from the open state to the closed state.

Example 102. The method of any example herein, particularly any one of examples 93-101, wherein the translating the actuator from the initial actuator position to the second actuator position comprises translating the actuator along a tool base of the module installation tool.

Example 103. The method of any example herein, particularly any one of examples 93-102, wherein the translating the actuator from the initial actuator position to the second actuator position comprises translating the actuator without rotating the actuator.

Example 104. The method of any example herein, particularly any one of examples 93-103, wherein the translating the actuator from the second actuator position to the third actuator position comprises translating the actuator without rotating the actuator.

Example 105. The method of any example herein, particularly any one of examples 93-104, wherein the translating the actuator from the second actuator position to the third actuator position operates to rotate the tool head relative to the module receiver without translating the tool head relative to the module receiver.

Example 106. The method of any example herein, particularly any one of examples 93-105, wherein the module installation tool comprises: an inner slider configured to translate axially relative to the tool head; a tool head guide track defined by one or both of the inner slider and the tool head; and a tool head rotation driver fixed in position relative to one of the inner slider or the tool head, and wherein the translating the actuator from the second actuator position to the third actuator position comprises driving the tool head rotation driver at least partially along a removal path of the tool head guide track to rotate the tool head relative to the inner slider.

Example 107. The method of any example herein, particularly example 106, wherein the tool head guide track comprises a first terminal location and a second terminal location, wherein the removal path interconnects the first terminal location and the second terminal location, wherein the translating the actuator from the second actuator position to the third actuator position comprises moving the tool head rotation driver from the second terminal location to a removal path intermediate location of the removal path, and wherein the method further comprises translating the actuator from the third actuator position to the second actuator position to move the tool head rotation driver from the removal path intermediate location to the first terminal location to further rotate the tool head relative to the module in the removal rotational direction.

Example 108. The method of any example herein, particularly any one of examples 93-107, further comprising, subsequent to the translating the actuator from the second actuator position to the third actuator position, translating the actuator from the third actuator position to the second actuator position.

Example 109. The method of any example herein, particularly example 108, wherein the translating the actuator from the third actuator position to the second actuator position causes the tool head to rotate relative to the module receiver further in the removal rotational direction.

Example 110. The method of any example herein, particularly any one of examples 108-109, wherein the translating the actuator from the third actuator position to the second actuator position causes the module to be uncoupled from the module receiver.

Example 111. The method of any example herein, particularly any one of examples 93-110, further comprising, prior to the translating the actuator to the third actuator position, transitioning a tool head interlock of the module installation tool from a locked configuration to an unlocked configuration to permit motion of a portion of the module installation tool relative to the tool head in the proximal direction.

Example 112. The method of any example herein, particularly example 111, wherein the transitioning the tool head interlock from the locked configuration to the unlocked configuration comprises urging the tool head interlock into engagement with the module receiver to translate the tool head in a proximal direction relative to the tool head interlock.

In view of the many possible examples in which the principles of the disclosed technology may be applied, it should be recognized that the illustrated examples are only preferred examples of the invention and should not be taken as limiting the scope of the technology. Rather, the scope of the invention is defined by the following claims. We therefore claim as our invention all that comes within the scope and spirit of these claims.

We claim:

1. A module installation tool, comprising:
a tool head configured to engage and support a module wherein the module is configured to be selectively coupled to a module receiver;
a tool base; and
an actuator slidably coupled to the tool base to provide an axial motion of the actuator relative to the tool base, wherein the axial motion is configured to cause the tool head to rotate relative to the tool base to couple the module to the module receiver or to uncouple the module from the module receiver.

2. The module installation tool of claim 1, wherein the actuator is configured to move from a first actuator position to a second actuator position that causes the tool head to translate relative to the tool base without rotating relative to the tool base, and wherein the actuator is configured to move from the second actuator position to a third actuator position that causes the tool head to rotate relative to the tool base without translating relative to the tool base.

3. The module installation tool of claim 2, wherein the actuator is configured to move from the second actuator position to the third actuator position that causes the tool head to rotate relative to the tool base in a rotational direction, and wherein the actuator is configured to subsequently move from the third actuator position to the second actuator position that causes the tool head to further rotate relative to the tool base in the same rotational direction.

4. The module installation tool of claim 2, wherein the tool head is configured to be transitioned among a plurality of configurations including a first initial configuration and a second initial configuration, wherein, when the tool head is in the first initial configuration with the actuator in the second actuator position, moving the actuator from the second actuator position to the third actuator position causes the tool head to rotate relative to the tool base in an installation rotational direction, and wherein, when the tool head is in the second initial configuration with the actuator in the second actuator position, moving the actuator from the second actuator position to the third actuator position causes the tool head to rotate relative to the tool base in a removal rotational direction opposite to the installation rotational direction.

5. The module installation tool of claim 1, further comprising an inner slider configured to translate relative to each of the tool base and the tool head, wherein axial translation of the inner slider relative to the tool head causes rotation of the tool head relative to the tool base, and wherein moving the actuator relative to the tool base causes the inner slider to translate relative to the tool base.

6. The module installation tool of claim 5, further comprising a magnetic coupling mechanism that magnetically couples the actuator and the inner slider to one another.

7. The module installation tool of claim 1, wherein the module comprises an ion source, wherein the module receiver is comprised in a mass spectrometer system, and wherein the apparatus is configured to install the module to the mass spectrometer system and to remove the module from the mass spectrometer system.

8. The module installation tool of claim 7, further comprising the mass spectrometer system.

9. A module installation tool, comprising:
a tool head configured to engage and support a module that is configured to be selectively coupled to a module receiver;
a tool base;
an actuator slidably coupled to the tool base; and
an inner slider at least partially received within the tool base and configured to translate relative to each of the tool base and the tool head,
wherein moving the actuator relative to the tool base causes the inner slider to translate relative to the tool base, wherein the apparatus is configured such that moving the actuator axially relative to the tool base transitions the apparatus among a plurality of configurations defined between and including a retracted configuration, in which the tool head is in a first axial position relative to the tool base, and an extended configuration, in which the tool head is in a second axial position relative to the tool base that is displaced from the first axial position along a proximal direction, and wherein the apparatus is configured to rotate the tool head relative to the tool base while the tool head remains in the second axial position.

10. The module installation tool of claim 9, wherein the actuator is in a first actuator position relative to the tool base when the apparatus is in the retracted configuration, wherein the actuator is in a second actuator position relative to the tool base when the apparatus is in the extended configuration, and wherein moving the actuator from the second actuator position to a third actuator position relative to the tool base causes the tool head to rotate relative tool base while the tool head remains in the second axial position.

11. The module installation tool of claim 9, further comprising:
a tool head guide track defined by one or both of the inner slider and the tool head; and
a tool head rotation driver fixed in position relative to one of the inner slider or the tool head, and
wherein translating the inner slider relative to the tool head causes the tool head rotation driver to travel along the tool head guide track to rotate the tool head relative to the tool base.

12. The module installation tool of claim 11, wherein the tool head guide track comprises:
a first terminal location;
a second terminal location;
an installation path connecting the first terminal location and the second terminal location; and
a removal path connecting the first terminal location and the second terminal location,
wherein the apparatus is configured such that the tool head rotates relative to the tool base in an installation rotational direction as the tool head rotation driver moves from the first terminal location to the second terminal location along the installation path, and wherein the apparatus is configured such that the tool head rotates relative to the tool base in a removal rotational direction opposite to the installation rotational direction when the tool head rotation driver moves from the second terminal location to the first terminal location via the removal path.

13. The module installation tool of claim 12, wherein, when the tool head rotation driver is at the first terminal location, moving the inner slider relative to the tool head with the actuator causes the tool head rotation driver to follow the installation path to the second terminal location, and wherein, when the tool head rotation driver is at the second terminal location, moving the inner slider relative to the tool head with the actuator causes the tool head rotation driver to follow the removal path to the first terminal location.

14. The module installation tool of claim 9, further comprising a tool head interlock that selectively restricts the inner slider from translating relative to the tool head, wherein the tool head interlock is configured to be transitioned between a locked configuration, in which the inner slider is restricted from translating relative to the tool head, and an unlocked configuration, in which the inner slider is free to translate relative to the tool head, and wherein the tool head interlock is configured to transition to the unlocked configuration when the apparatus is in the extended configuration with the tool head interlock engaging the module receiver.

15. A method comprising:
with a module operatively coupled to a tool head of a module installation tool, translating an actuator of the module installation tool in a proximal direction from an initial actuator position to a second actuator position to bring the module into engagement with a module receiver;
translating the actuator in the proximal direction from the second actuator position to a third actuator position to rotate the tool head relative to the module receiver in an installation rotational direction to at least partially couple the module to the module receiver; and
detaching the module from the tool head.

16. The method of claim 15, wherein the translating the actuator from the second actuator position to the third actuator position comprises translating the actuator without rotating the actuator.

17. The method of claim 15, further comprising, subsequent to the translating the actuator from the second actuator position to the third actuator position, translating the actuator from the third actuator position to the second actuator position, wherein the translating the actuator from the third actuator position to the second actuator position causes the tool head to rotate relative to the module receiver further in the installation rotational direction.

18. The method of claim 15, wherein the module installation tool comprises:
an inner slider configured to translate axially relative to the tool head;
a tool head guide track defined by one or both of the inner slider and the tool head; and
a tool head rotation driver fixed in position relative to one of the inner slider or the tool head, and
wherein the translating the actuator from the second actuator position to the third actuator position comprises driving the tool head rotation driver at least partially along an installation path of the tool head guide track to rotate the tool head relative to the inner slider.

19. The method of claim 18, wherein the tool head guide track comprises a first terminal location and a second terminal location, wherein the installation path interconnects the first terminal location and the second terminal location, wherein the translating the actuator from the second actuator position to the third actuator position comprises moving the tool head rotation driver from the first terminal location to an installation path intermediate location of the installation path, and wherein the method further comprises translating the actuator from the third actuator position to the second actuator position to move the tool head rotation driver from the installation path intermediate location to the second terminal location to further rotate the tool head relative to the module in the installation rotational direction.

20. The method of claim 15, wherein the module installation tool comprises a tool base that supports the tool head, and wherein each of the translating the actuator from the initial actuator position to the second actuator position, the translating the actuator from the second actuator position to the third actuator position, and the detaching the module from the tool head is performed while the tool base is operatively coupled to a tool receiver that is fixed in position relative to the module receiver.
